(19) United States
(12) Patent Application Publication
(10) Pub. No.: US 2004/0133541 A1
(43) Pub. Date: Jul. 8, 2004

(54) Method of pattern discovery

(76) Inventors: David Meredith, Wisbech (GB); Geraint Wiggins, London (GB); Kjell Lemstrom, Espoo (FI)

Correspondence Address: Richard C Woodbridge, Synnestvedt Lechner & Woodbridge, PO Box 592, Princeton, NJ, 08542-0592, US

(21) Appl. No.: 10/478,458

(22) PCT Filed: May 23, 2002
(86) PCT No.: PCT/GB02/02430

(30) Foreign Application Priority Data
May 23, 2001 (GB) 0112551.7
Jan. 7, 2002 (GB) 0200203.8

(51) Int. Cl. G06F 7/00

(52) U.S. Cl. 707/1

(57) ABSTRACT

This invention provides methods for pattern discovery, pattern matching and data compression in multidimensional numerical datasets. The invention can usefully be applied in any domain in which information represented in the form of multidimensional datasets needs to be retrieved, compared, analysed or compressed. Such domains include 2D images, audio and video data, biomolecular data, seismic, meteorological and financial data. There already exist methods for pattern discovery, pattern matching and data compression but these methods have been designed for processing data represented as strings and there are many domains in which data cannot be appropriately represented using strings. In such domains, existing data-processing methods are not effective. In many of the domains in which strings cannot be effectively used to represent information (e.g., audio and video data), the data can be represented using multidimensional numerical datasets. The present invention provides methods for processing such datasets. The method allows maximal matches for a query pattern to be found in a dataset by computing the inter-datapoint vectors between datapoints in the pattern and datapoints in the dataset. The method allows maximal recurring pattern in a the dataset to be found by computing inter-datapoint vectors between datapoints in the dataset. An extension of the method allows all occurrences of all maximal recurring patterns in a dataset to be found. This extension to the method can be used to compute a compressed (i.e. space-efficient) representation of a dataset from which the dataset can be reconstructed by multiple translations of an optimal set of generating patterns.

### FIELD OF THE INVENTION

This invention relates to the fields of pattern matching, pattern discovery and data compression. In particular, it relates to pattern matching, pattern discovery and data compression in multidimensional numerical data.

Pattern discovery, pattern matching and data compression in multidimensional numerical datasets can be used in many areas such as audio and video compression, data indexing and drug design.

### RELATED ART

Algorithms already exist for data compression, information retrieval and structural analysis of data. However, most existing approaches are based on string matching techniques that require the datasets to be represented as strings of characters before they are processed. In other words, most existing approaches attempt to process multidimensional numerical data using techniques originally designed for processing one-dimensional textual data. String-based approaches to processing multidimensional datasets are artificially limited as to the types of patterns that can be discovered and searched for; and certain information-retrieval tasks (such as, for example, searching for patterns with gaps in multidimensional data) are unnecessarily awkward to accomplish using these techniques. For an overview of string-matching techniques in general, see Crochemore and Rytter (1994). For an introduction to pattern-matching techniques in bioinformatics, see Gusfield (1997).

Although previous approaches to pattern matching, pattern discovery and data compression are based on the assumption that the data to be processed is represented in the form of a string of symbols or as a set of such symbol strings, there are many domains in which data cannot be appropriately represented using strings. In such domains, existing methods for pattern matching, pattern discovery and data compression are not effective. In many domains in which information cannot appropriately be represented using strings, multidimensional numerical datasets can be used instead.

### SUMMARY OF THE INVENTION

In a first aspect of the present invention, there is a method of pattern discovery in a dataset, in which the dataset is represented as a set of datapoints in an n-dimensional space, comprising the step of computing inter-datapoint vectors.

The present invention is based on the insight that the properties of multidimensional datasets can be expressed naturally in geometrical terms (using concepts such as vectors, points and geometrical transformations like translation) and that pattern discovery can be based on computing inter-datapoint vectors. Multidimensional datasets can therefore be directly analysed using the mathematical concepts and theory that were originally developed for manipulating this kind of data. More specifically, in an implementation designed to identify translation invariant sets of datapoints within the dataset, the method comprises the further steps of:

(a) computing the largest set of datapoints that can be translated by a given inter-datapoint vector to another set of datapoints in the dataset; and

(b) computing all sets of datapoints which are translationally equivalent to the largest set identified in step (a).

This method of finding internal recurring structures within a multi-dimensional dataset can be used (without limitation) for any of the following purposes:

(a) lossless data-compression;

(b) predicting the future price of a tradable commodity;

(c) locating repeating elements in a molecule; and

(d) indexing.

A pattern matching implementation of the present invention further differs over the prior art as follows: most existing approaches to pattern-discovery and pattern-matching employ techniques based on the idea of trying to align a query pattern (e.g. a user-supplied regular expression) against the dataset at each possible position. Implementations of the present invention eschew alignment-based techniques in favour of a data driven approach based on the fact that if there exists a pattern P in a dataset that is translationally in-variant to a query pattern Q, then there will exist at least one query pattern datapoint q and one dataset point p such that the vector that maps q onto p is equal to the vector that maps Q onto P. Hence, in an implementation adapted to identify the occurrence of a user supplied set of datapoints in a dataset, the method comprises the further steps of:

(a) computing inter-datapoint vectors from each datapoint in the user supplied set of datapoints to each datapoint in the dataset;

(b) computing the largest set of datapoints in the user supplied set of datapoints that can be translated by a given inter-datapoint vector to another set of datapoints in the dataset.

This implementation can be used (without limitation) for any of the following purposes:

(a) locating specific elements in a molecule;

(b) visual pattern comparison;

(c) speech or music recognition.

The present invention finds broad application whenever multi-dimensional datasets need to be analysed for internal patterns or for matches against external queries. Typically, datapoints in an n-dimensional space can therefore represent any of the following:

(a) audio data;

(b) 2D image data;

(c) 3D representations of virtual spaces;

(d) video data;

(e) molecular structure;

(f) chemical spectra;

(g) financial data;

(h) seismic data;

(i) meteorological data;

(j) symbolic music representations;

(k) CAD circuit data.

In another aspect of the invention, there is provided computer software adapted to perform the method described above.

### LIST OF FIGURES AND TABLES

The present invention will be described with reference to the accompanying drawings and tables, a brief description of which follows.

FIG. 1(a) shows a simple 2-dimensional dataset. (b)-(j) show the maximal repeated patterns found by SIA in the dataset in (a).

FIG. 2 The sets of patterns discovered by SIATEC in the dataset in FIG. 1(a).

FIG. 3 When SIAME searches for occurrences of the query pattern (a) in the dataset (b), it finds the exact matches shown in (c). It also finds the closest incomplete matches shown in (d).

FIG. 4(b) shows the compressed representation generated by COSIATEC for the dataset (a). The dataset in (a) can be generated by translating the three-point pattern in (b) by the three vectors represented by arrows.

FIG. 5 The set S(D) for the dataset in FIG. 1(a).

FIG. 6 The set T(D) for the dataset in FIG. 1(a).

FIG. 7 An algorithm for printing out S(D) using V and D.

FIG. 8 The output of the algorithm in FIG. 7 for the dataset in FIG. 1(a).

FIG. 9 An algorithm for computing X using V and D.

FIG. 10 The ordered set X for the dataset in FIG. 1(a).

FIG. 11 The ordered set Y for the dataset in FIG. 1(a).

FIG. 12 An algorithm for printing out T(D).

FIG. 13 The PRINT_PATTERN algorithm.

FIG. 14 The PRINT_SET_OF_TRANSLATORS algorithm.

FIG. 15 The output of the algorithm in FIG. 12 for the dataset in FIG. 1(a).

FIG. 16 The ordered set V_{SIAME} computed by Step 2 of SIAME for the pattern in FIG. 3(a) and the dataset in FIG. 3(b).

FIG. 17 An algorithm for computing N using V_{SIAME}.

FIG. 18 N for the pattern in FIG. 3(a) and the dataset in FIG. 3(b).

FIG. 19 N′ for the pattern in FIG. 3(a) and the dataset in FIG. 3(b).

FIG. 20 An algorithm for computing M′(P, D) from N′ and V_{SIAME}.

FIG. 21 M for the pattern in FIG. 3(a) and the dataset in FIG. 3(b).

FIG. 22 The COSIATEC algorithm.

FIG. 23 Globally defined data types used in the algorithms.

FIG. 24 The SIA algorithm.

FIG. 25 The READ_VECTOR_SET algorithm.

FIG. 26 The SORT_DATASET algorithm.

FIG. 27 The MERGE_DATASET_ROWS algorithm.

FIG. 28 The SETIFY_DATASET algorithm.

FIG. 29 The SIA_COMPUTE_VECTORS algorithm.

FIG. 30 The SIA_SORT_VECTORS algorithm.

FIG. 31 The SIA_MERGE_VECTOR_COLUMNS algorithm.

FIG. 32 The PRINT_VECTOR_MTP_PAIRS algorithm.

FIG. 33 The SIATEC algorithm.

FIG. 34 The COMPUTE_VECTORS algorithm.

FIG. 35 The CONSTRUCT_VECTOR_TABLE algorithm.

FIG. 36 The SORT_VECTORS algorithm.

FIG. 37 The MERGE_VECTOR_COLUMNS algorithm.

FIG. 38 The VECTORIZE_PATTERNS algorithm.

FIG. 39 The SORT_PATTERN_VECTOR_SEQUENCES algorithm.

FIG. 40 The MERGE_PATTERN_ROWS algorithm.

FIG. 41 The PRINT_TECS algorithm.

FIG. 42 The PRINT_PATTERN algorithm.

FIG. 43 The PRINT_SET_OF_TRANSLATORS algorithm.

FIG. 44 The COSIATEC algorithm.

FIG. 45 The DISPOSE_OF_SIATEC_DATA_STRUCTURES algorithm.

FIG. 46 The READ_TEC algorithm.

FIG. 47 The SET_TEC_COVERED_SET algorithm.

FIG. 48 The IS_BETTER_TEC algorithm.

FIG. 49 The PRINT_TEC algorithm.

FIG. 50 The PRINT_VECTOR_SET algorithm.

FIG. 51 The DELETE_TEC_COVERED_SET algorithm.

FIG. 52 Example of format used as input to READ_VECTOR_SET algorithm.

FIG. 53 Using NUMBER_NODEs to represent vectors.

FIG. 54 A right-directed list of VECTOR_NODEs.

FIG. 55 A down-directed list of VECTOR_NODEs.

FIG. 56 The linked list constructed by READ_VECTOR_SET when F is the data in FIG. 52, DIR=DOWN and SD=“101”.

FIG. 57 The linked list constructed by READ_VECTOR_SET when F is the data in FIG. 52, DIR=RIGHT and SD=NULL.

FIG. 58 Example input data.

FIG. 59 The linked list generated by line 5 of SIA (FIG. 24) for the data in FIG. 58.

FIG. 60 The state of the linked list D after one iteration of the outer while loop of SORT_DATASET on the dataset list in FIG. 59.

FIG. 61 The sorted, right-directed linked list produced by SORT_DATASET from the unsorted, down-directed dataset list in FIG. 59.

FIG. 62 The linked list that results when SETIFY_DATASET has been executed on the linked list in FIG. 61.

FIG. 63 The data structure that results after SIA_COMPUTE_VECTORS has executed when the SIA algorithm in FIG. 24 is carried out on the dataset shown in FIG. 1(a).

FIG. 64 The data structure headed by V after SIA_SORT_VECTORS has executed when SIA is carried out on the dataset in FIG. 1(a).

FIG. 65 The output generated by PRINT_VECTOR_MTP_PAIRS (FIG. 32) for the dataset in FIG. 1(a).

FIG. 66 The data structure generated by COMPUTE_VECTORS for the dataset in FIG. 1(a).

FIG. 67 The data structures that result after CONSTRUCT_VECTOR_TABLE has executed when the SIATEC implementation in FIG. 33 is run on the dataset in FIG. 1(a).

FIG. 68 The data structures that result after SORT_VECTORS has executed when the SIATEC implementation in FIG. 33 is run on the dataset in FIG. 1(a).

FIG. 69 Diagrammatic representation of an X_NODE.

FIG. 70 The state of the data structures headed by D, V and X in the SIATEC implementation in FIG. 33 after line 27 has been executed when this implementation is run on the dataset in FIG. 1(a).

FIG. 71 The state of the data structures headed by D, V and X in the SIATEC implementation in FIG. 33 after line 28 has been executed when this implementation is run on the dataset in FIG. 1(a).

FIG. 72 The output generated by PRINT_TECS (FIG. 41) for the dataset in FIG. 1(a).

FIG. 73 The output generated by COSIATEC (FIG. 44) for the dataset in FIG. 4.

FIG. 74 An illustration of the data structures used in SIAME.

FIG. 75 The NEWLINK algorithm.

FIG. 76 First implementation of SIAME algorithm.

FIG. 77 Second implementation of SIAME.

FIG. 78 The MERGEDUPLICATES algorithm.

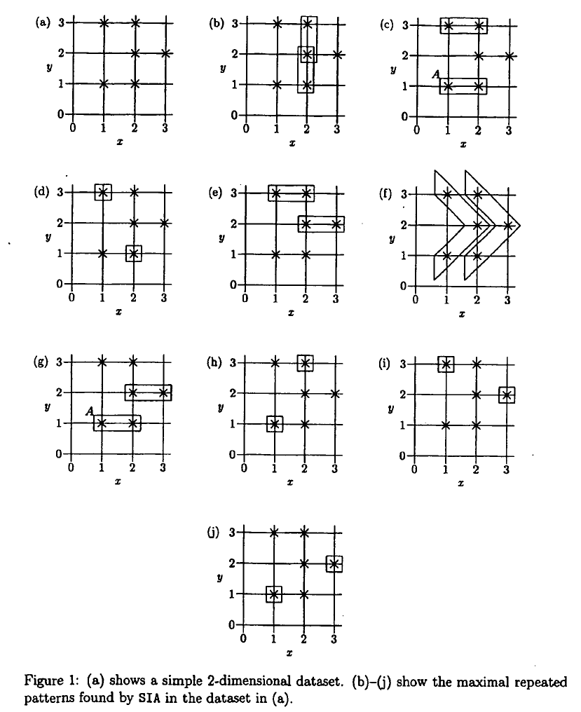

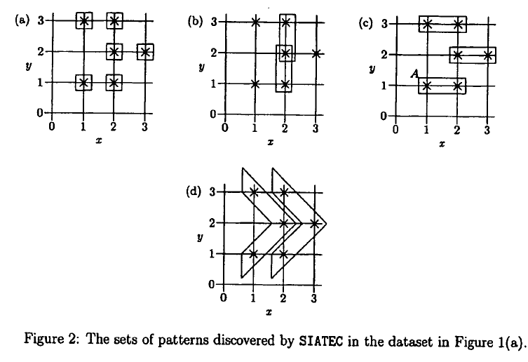

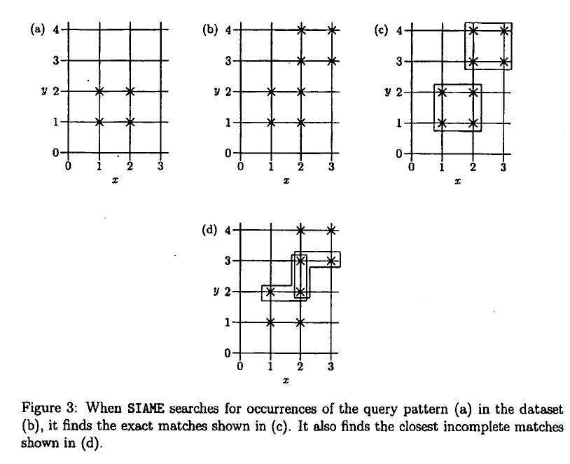

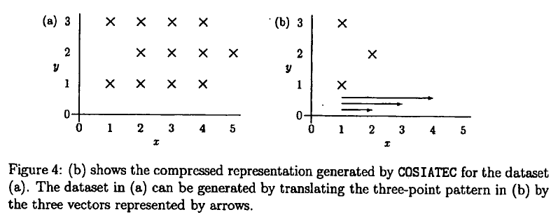

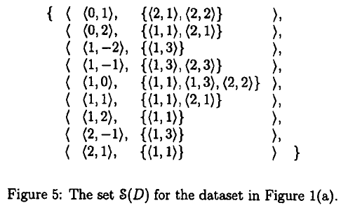

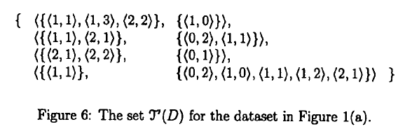

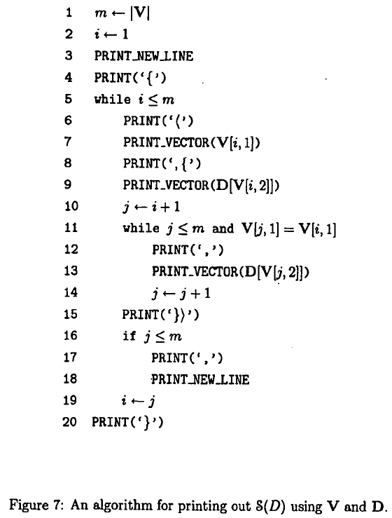

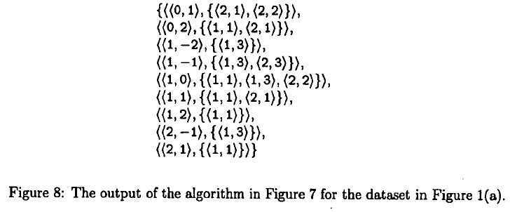

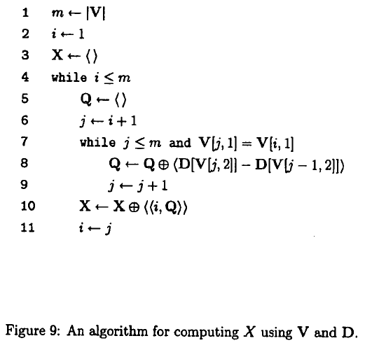

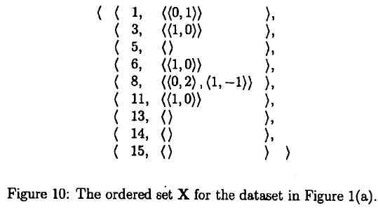

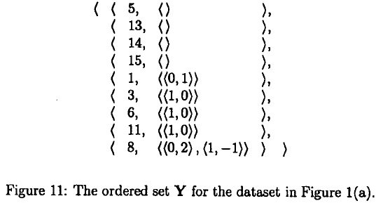

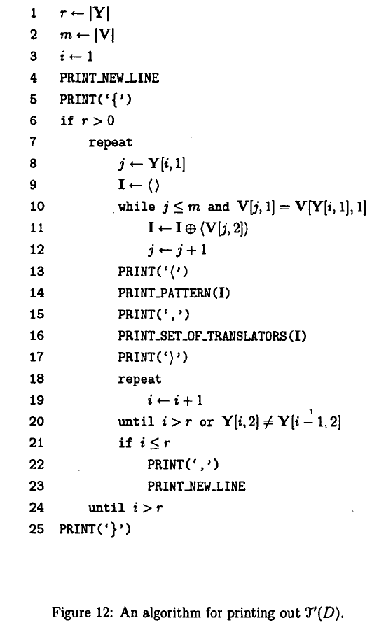

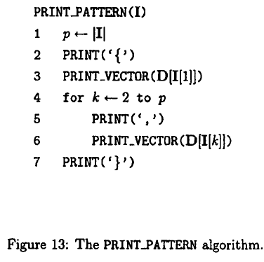

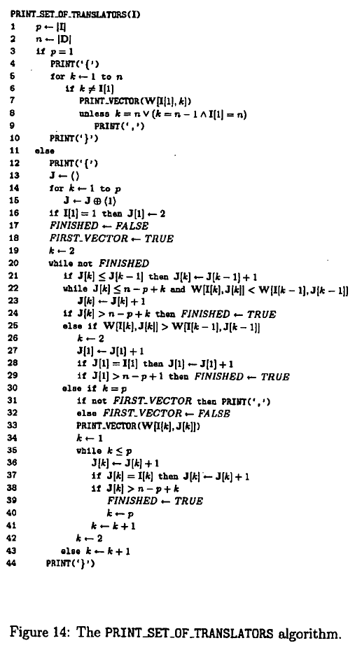

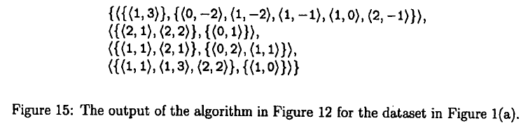

### Table 1 A vector table showing the set V for the dataset shown in FIG. 1(a).

Table 2 Reading the second column from top to bottom gives V for the dataset shown in FIG. 1(a). The third column gives D[V[i,2]] for each element V[i] in the second column. The right-hand side of the third column shows how the non-empty MTPs may be derived directly from V.

Table 3 A vector table showing W for the dataset shown in FIG. 1(a).

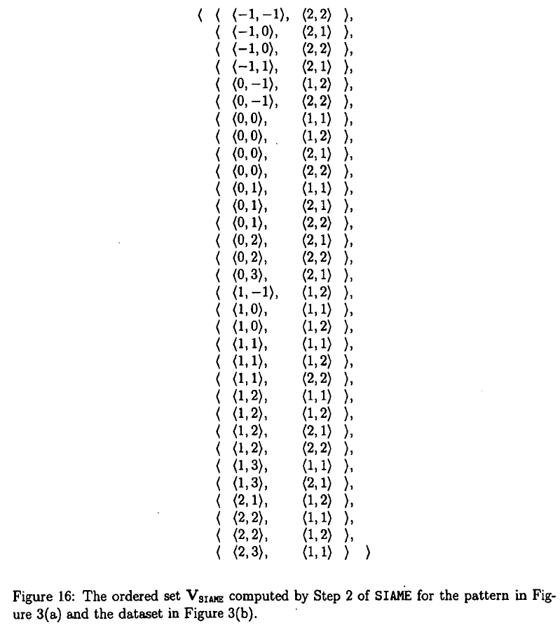

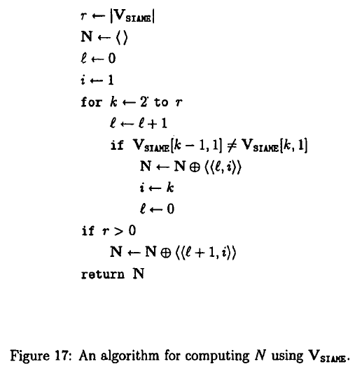

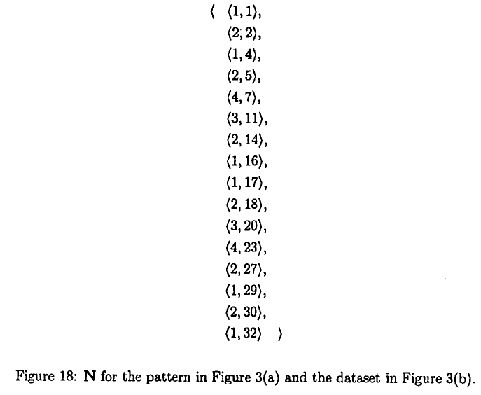

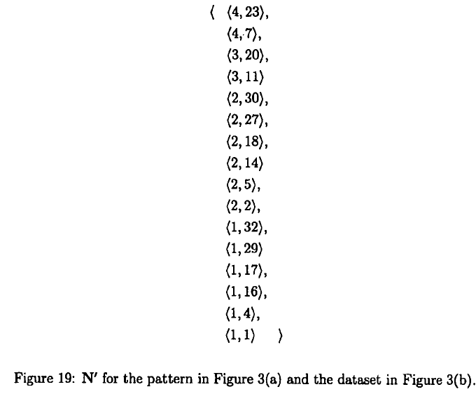

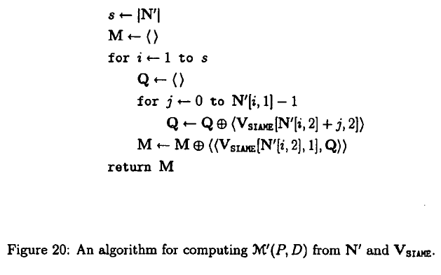

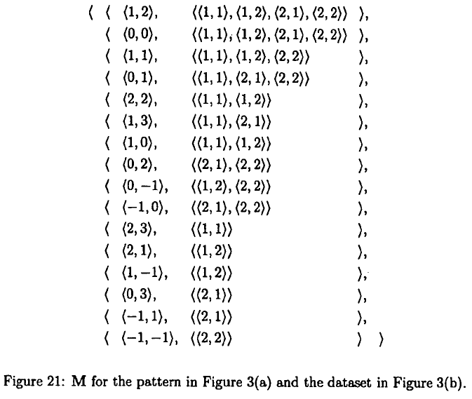

Table 4 A vector table showing the set V_{SIAME} generated by Step 1 of SIAME for the query pattern in FIG. 3(a) and the dataset in FIG. 3(b).

### DETAILED DESCRIPTION OF PREFERRED IMPLEMENTATIONS

The aim of the present invention is to provide methods for pattern matching, pattern discovery and data compression in multidimensional datasets. More specifically, the following four related algorithms are described:

1. an algorithm called SIA that takes a multidimensional dataset as input and computes all the largest repeated patterns in the dataset;

2. an algorithm called SIATEC that takes a multidimensional dataset as input and computes all the occurrences of all the largest repeated patterns in the dataset;

3. an algorithm called SIAME that takes a multidimensional query pattern and a multidimensional dataset as input and finds all partial and complete occurrences of the query pattern in the dataset; and

4. an algorithm called COSIATEC that takes a multidimensional dataset as input and computes a compressed (i.e. space-efficient) representation of the dataset (i.e., it losslessly compresses the dataset).

SIA discovers the largest (or ‘maximal’) repeated patterns in a multidimensional dataset. For example, if the 2-dimensional dataset shown in FIG. 1(a) is given to SIA as input, SIA discovers the pairs of patterns shown in FIGS. 1(b)-(j).

SIATEC first uses SIA to find all the maximal repeated patterns and then it finds all the occurrences of these patterns in the dataset. FIGS. 2(a)-(d) shows the output of SIATEC for the dataset in FIG. 1(a).

SIA and SIATEC are pattern discovery algorithms: they autonomously discover repeated structures in data. SIAME, on the other hand, is an information-retrieval or pattern matching algorithm: the user supplies a query pattern and a dataset and SIAME searches the dataset for occurrences of the query pattern. For example, if a molecular biologist wanted to find all the occurrences of the purine base adenine in a DNA molecule, he/she could give SIAME two items of input:

1. a multidimensional representation of adenine as the query pattern; and

2. a multidimensional representation of the DNA molecule as the dataset.

SIAME would then output a list indicating, first, all the exact occurrences of adenine in the DNA molecule; then, all the closest incomplete matches (i.e., one atom different); then all the incomplete matches with two atoms different; and so on. SIAME can also be used to compare datasets: the two datasets to be compared are given to SIAME as input and SIAME computes all the ways in which the two datasets may be matched, returning the best matches first. FIG. 3(c) shows the exact matches found by SIAME for the query pattern in FIG. 3(a) in the dataset in FIG. 3(b). FIG. 3(d) shows the closest incomplete matches found by SIAME for the same query pattern in the same dataset.

COSIATEC generates a compressed representation of a dataset by repeatedly applying SIATEC. For example, FIG. 4(a) shows the dataset

{ [symbol] 1, 1 [symbol] , [symbol] 1, 3 [symbol] , [symbol] 2, 1 [symbol] , [symbol] 2, 2 [symbol] , [symbol] 2, 3 [symbol] , [symbol] 3, 1 [symbol] , [symbol] 3, 2 [symbol] , [symbol] 3, 3 [symbol] , [symbol] 4, 1 [symbol] , [symbol] 4, 2 [symbol] , [symbol] 4, 3 [symbol] , [symbol] 5, 2 [symbol] }.

Note that to store this dataset explicitly, 12 vectors need to be specified, one for each datapoint in the dataset. When this dataset is given as input to COSIATEC, the algorithm generates the following ordered pair of sets

[symbol]

{ [symbol] 1, 1 [symbol] , [symbol] 1, 3 [symbol] , [symbol] 2, 2 [symbol] }, { [symbol] 1, 0 [symbol] , [symbol] 2, 0 [symbol] , [symbol] 3, 0 [symbol] }

[symbol]

The first set of vectors in this ordered pair, { [symbol] 1, 1 [symbol] , [symbol] 1, 3 [symbol] , [symbol] 2, 2 [symbol] }, represents the three-point pattern shown in FIG. 4(b). The second set of vectors, { [symbol] 1, 0 [symbol] , [symbol] 2, 0 [symbol] , [symbol] 3, 0 [symbol] }, represents the three translation vectors indicated by arrows in FIG. 4(b). The dataset in FIG. 4(a) can be generated by translating the three-point pattern in FIG. 4(b) by the vectors indicated by the arrows in the diagram. Note that to store this compressed representation, only 6 vectors need to be specified. In this particular case, therefore, COSIATEC generates a compressed representation that uses only half the space used to store the original dataset. The degree of compression achievable using COSIATEC depends on the amount of repetition in the dataset to be compressed.

1 The Mathematical Functions Computed by the Algorithms

1.1 Preliminary Mathematical Concepts

Before specifying the mathematical functions computed by the SIA, SIATEC, COSIATEC and SIAME algorithms, it is necessary to define some preliminary mathematical concepts.

A vector is a k-tuple of real numbers viewed as a member of a k-dimensional Euclidean space (Borowski and Borwein, 1989, p. 624, s.v. vector, sense 2). A vector in a k-dimensional Euclidean space will be represented here as an ordered set of k real numbers.

If A is an ordered set or a vector then we denote the cardinality of A by |A| and the ith element of A by A[i]. If u and v are two vectors such that |u|=|v|=k then we say that u is less than v, denoted by u<v, if and only if there exists an integer i such that 1≦i≦k and u[i]<v[i] and u[j]=v[j] for 1≦j<i. For example, [symbol] 1, 1 [symbol] < [symbol] 1, 2 [symbol] < [symbol] 2, 1 [symbol] .

If A and B are ordered sets such that A= [symbol] a₁, a₂, . . . aₘ [symbol] and B= [symbol] b₁, b₂, . . . bₙ [symbol] then the concatenation of B onto A, denoted by A⊕B, is defined to be equal to

[symbol]

a₁, a₂, . . . aₘ, b₁, b₂, . . . bₙ

[symbol]

If S₁, S₂, . . . Sₖ, . . . Sₙ is a collection of ordered sets then the expression

S₁⊕S₂⊕ . . . Sₖ⊕ . . . ⊕Sₙ

is defined to be equivalent to

$${{⊕}_{k = 1}}^{n} {S}_{k} .$$

In set theory, recall that ∅ denotes the empty set and that A\B denotes the set that contains all elements of A except those that are also elements of B. Otherwise, a knowledge of basic set theory and notation will be assumed.

An object is a vector set if and only if it is a set of vectors. An object is a k-dimensional vector set if and only if it is a vector set in which every vector has cardinality k.

An object may be called a pattern or a dataset if and only if it is a k-dimensional vector set. An object may be called a datapoint if and only if it is a vector in a pattern or a dataset. We usually reserve the term dataset for a k-dimensional vector set that represents some complete set of data that we are interested in processing. We usually reserve the term pattern for a k-dimensional vector set that is a subset of some specified dataset or a transformation of some subset of a dataset. Also, if we have two k-dimensional vector sets P and D and we wish to search for occurrences of P in D then we would usually refer to P as a pattern and D as a dataset.

Let D be a dataset and let d₁ and d₂ be any two datapoints in D. The vector from d₁ to d₂ is given by d₂−d₁ where the minus sign denotes vector subtraction. If v=d₂−d₁ then d₂=v+d₁ (‘+’ here denotes vector addition) which expresses the fact that the datapoint d₁ can be translated by the vector v to give the datapoint d₂.

We denote by τ(P, v) the pattern that results when the pattern P is translated by the vector v. Formally,

τ(P, v)={d+v|d∈P} (1)

We say that two patterns P₁ and P₂ are translationally equivalent, denoted by P₁≡_{τ}P₂, if and only if there exists a vector v such that τ(P₁, v)=P₂. We say that a pattern P is translatable by a vector v in a dataset D if and only if τ(P, v)⊂ D.

The maximal translatable pattern (MTP) for a vector v in a dataset D, denoted by MTP(v, D), is the largest pattern translatable by v in D. Formally,

MTP(v, D)={d|d∈DΛd+v∈D} (2)

The MTP for a vector v in a dataset D is non-empty if and only if there exist at least two datapoints d₁ and d₂ in D such that v=d₂−d₁. This implies that the complete set of non-empty MTPs for a dataset D is given by

P(D)={MTP(d₂−d₁, D)|d₁, d₂∈D} (3)

1.2 The Function Computed by SIA

SIA computes all the non-empty MTPs in a dataset. However, it is not necessary for SIA to compute explicitly all the elements of P(D) in Eq.3, because, in general, if the MTP for v is translated by v, the resulting pattern is the MTP for the vector −v. This will now be proved.

Lemma 1 If D is a dataset and v is a vector then

τ(MTP(v, D), v)=MTP(−v, D) (4)

Proof

From Eq.1 we deduce that

τ(MTP(v, D), v)={(d₁+v|d₁∈MTP(v, D)} (5)

Substituting Eq.2 into Eq.5, we find that

$$\begin{matrix}τ ( MTP ( v , D ) , v ) = \{ {d}_{1} + v \vert {d}_{1} ∈ \{ {d}_{2} \vert {d}_{2} ∈ D ⋀ {d}_{2} + v ∈ D \} \} \\ = \{ {d}_{2} + v \vert {d}_{2} ∈ D ⋀ {d}_{2} + v ∈ D \} .\end{matrix} \qquad ( 6 )$$

If we let d₃=d₂+v and substitute this into Eq.6, we deduce that

τ(MTP(v, D), v)={d₃|d₃−v∈DΛd₃∈D} (7)

Eqs.7 and 2 together imply

τ(MTP(v, D), v)=MTP(−v, D).

Lemma 1 tells us that if we compute MTP(d₂−d₁, D) then we can find MTP(d₁−d₂, D) simply by translating MTP(d₂−d₁, D) by d₂−d₁. It is also clear that MTP(0, D)=D where 0 is the zero vector. These two facts imply that if our goal is only to compute all the non-empty MTPs in a dataset then we only really need to compute the set

P′(D)={MTP(d₂−d₁, D)|d₁, d₂∈DΛd₁<d₂} (8)

However, if SIA simply generated the set P′ (D), then it would not be possible to determine the vector for which any given element of P′ (D) was the MTP. Therefore, SIA actually computes the set

S(D)={ [symbol] d₂−d₁, MTP(d₂−d₁, D) [symbol] |d₁, d₂∈DΛd₁<d₂} (9)

Each member of S(D) is an ordered pair in which the first element is a vector v and the second element is the MTP for v in D. FIG. 5 shows S(D) for the dataset in FIG. 1(a).

1.3 The Function Computed by SIATEC

SIATEC computes all the occurrences of all the non-empty MTPs in a dataset. If D is a dataset and P⊂D is a pattern in D then we define the translational equivalence class (TEC) of P in D to be the set

TEC(P, D)={Q|Q≡_{τ}PΛQ⊂D} (10)

The four graphs in FIG. 2(a)-(d) show the four TECs computed by SIATEC for the dataset in FIG. 1(a). The aim of SIATEC is to compute efficiently all the TECs of all the non-empty MTPs for a dataset D, that is,

T(D)={TEC(MTP(d₂−d₁, D), D)|d₁, d₂∈D} (11)

The translational equivalence relation is reflexive, transitive and symmetric and partitions the power set of a dataset into translational equivalence classes. This means that every pattern in a dataset is a member of exactly one TEC. However, from Lemma 1 we know that

τ(MTP(d₂−d₁, D), d₂−d₁)=MTP(d₁−d₂, D).

Therefore

TEC(MTP(d₂−d₁, D), D)=TEC(MTP(d₁−d₂, D), D).

Moreover, we know that MTP(0, D)=D and therefore TEC(MTP(0, D), D)={D} which is a trivial translational equivalence class. Therefore, instead of computing T(D) as defined in Eq.11, SIATEC actually computes the set

T′(D)={TEC(MTP(d₂−d₁, D), D)|d₁, d₂∈DΛd₁<d₂} (12)

It can easily be seen that T(D)=T′(D)∪{{D}}.

If P is a pattern in a dataset D then we say that v is a translator of P in D if and only if P is translatable by v in D. The set of translators for P in D, which we denote by T(P, D), is the set that only contains all vectors by which P is translatable in D. Formally,

T(P, D)={v|τ(P, v)⊂D} (13)

For example, the set of translators for the three-point pattern in FIG. 4(b) is the set { [symbol] 0, 0 [symbol] , [symbol] 1, 0 [symbol] , [symbol] 2, 0 [symbol] , [symbol] 3, 0 [symbol] }. Any pattern P in a dataset D is translatable in D by the zero vector, 0. 0 is therefore considered a trivial translator. Any non-zero translator of a pattern P in a dataset D is a non-trivial translator of P in D. The set of non-trivial translators for a pattern P in a dataset D is therefore given by

T(P, D)\{0} (14)

The TEC of a pattern P in a dataset D can therefore be represented efficiently by the ordered pair [symbol] P,T(P,D)\{0} [symbol] . That is, [symbol] P,T(P,D)\{0} [symbol] denotes the set of patterns

$${⋃}_{v ∈ T ( P , D )} \{ τ ( P , v ) \} . \qquad ( 15 )$$

For any given TEC, E, there are |E| such representations, one for each pattern in E. In general, this ordered-pair representation for a TEC can be much more space-efficient than explicitly writing out every member pattern of the TEC in full. For example, if there are 20 patterns in a dataset that are translationally equivalent to a pattern P containing 10 datapoints, then printing out the TEC for P in full would involve printing 200 datapoints. However, if this TEC were represented as the ordered pair [symbol] P,T(P,D)\{0} [symbol] then only 10+19=29 vectors would need to be printed. This provides the basis for the compression algorithm, COSIATEC, described below.

In the output of SIATEC, each distinct TEC, E, in T′(D) is therefore represented as an ordered pair [symbol] P, T(P, D)\{0} [symbol] where P is a member of E and T(P,D) is the set of translators for P in D. FIG. 6 shows T′(D) for the dataset shown in FIG. 1(a).

1.4 The Function Computed by SIAME

SIAME takes a query pattern P and a dataset D and finds all the partial and complete translation-invariant occurrences of P in D. The maximal match (MM) for a query pattern P and a vector v in a dataset D, denoted by MM(P, v, D) is the set of datapoints in P that can be translated by v to give datapoints in D. Formally,

MM(P, v, D)={p|p∈PΛp+v∈D} (16)

Note that for any dataset D, MM(D, v, D)=MTP(v, D) (see Eq.2). The concept of a maximal match is therefore a generalization of the concept of a maximal translatable pattern. A maximal match MM(P, v, D) will be non-empty if and only if there exist two datapoints, p∈P, d∈D, such that v=d−p. The complete set of maximal matches for a pattern P and a dataset D is therefore given by

M(P, D)={MM(P, d−p, D)|d∈DΛp∈P} (17)

Note that M(D, D)=P(D) (see Eq.3). The aim of SIAME is to compute all the non-empty maximal matches for a given pattern and dataset. However, if SIAME simply generated the set M(P, D), it would be impossible to determine the vector for which each pattern in M(P, D) was a maximal match. SIAME therefore computes the set

M′(P, D)={ [symbol] d−p, MM(P, d−p, D) [symbol] |d∈DΛp∈P} (18)

1.5 The Mapping Computed by COSIATEC

COSIATEC uses SIATEC to generate a compressed representation of a dataset. As explained above, each TEC, E, in the output of SIATEC is represented as an ordered pair [symbol] P, T(P, D)\0 [symbol] such that

$$E = {⋃}_{v ∈ T ( P , D )} \{ τ ( P , v ) \} .$$

If E= [symbol] P, T(P, D)\0 [symbol] is a TEC in a dataset D, then the coverage of E, denoted by COV(E) is given by

$$COV ( E ) = \vert {⋃}_{Q ∈ E} Q \vert \qquad ( 19 )$$

and the compression ratio of E, denoted by CR(E) is defined to be

$$CR ( E ) = \frac{COV ( E )}{\vert P \vert + \vert T ( P , D ) \backslash 0 \vert} \qquad ( 20 )$$

We can now define ε_{best}(D) to be the set of TECs, E∈T′(D), for which the vector (CR(E), COV(E)) is a maximum (recall definition of vector inequality on page 12 above). That is, E∈ε_{best}(D) if and only if E∈T′(D) and there exists no E′∈T′(D) such that [symbol] CR(E), COV(E) [symbol] < [symbol] CR(E′), COV(E′) [symbol] .

COSIATEC takes a dataset D as input and computes an ordered set of TECs

[symbol]

E₁, E₂, . . . Eᵣ

[symbol]

satisfying the following conditions:

1. For all 1≦k≦r, Eₖ∈ε_{best}(Dₖ) where

$${D}_{k} = \{ \begin{matrix}D , & when k = 1 ; \\ {D}_{k - 1} \backslash {⋃}_{P ∈ {E}_{k - 1}} {P}_{,} & when 1 < k \leq r .\end{matrix}$$

2. Dᵣ≠∅ and Dᵣ₊₁=∅.

2 The Algorithms

The SIA, SIATEC, SIAME and COSIATEC algorithms will now be described. Detailed example implementations will then be presented in section 3.

2.1 The SIA Algorithm

When given a multidimensional dataset, D, as input, SIA computes S(D) as defined in Eq.9 above. For a k-dimensional dataset containing n datapoints, the worst-case running time of SIA is O(kn²log₂n) and its worst-case space complexity is O(kn²). The algorithm consists of the following four steps.

2.1.1 SIA: Step 1—Sorting the Dataset

The first step in SIA is to sort the dataset D to give an ordered set D that contains all and only the datapoints in D in increasing order. For the dataset in FIG. 1(a), the result of this first step would be the ordered set

D=( [symbol] 1, 1 [symbol] , [symbol] 1, 3 [symbol] , [symbol] 2, 1 [symbol] , [symbol] 2, 2 [symbol] , [symbol] 2, 3 [symbol] , [symbol] 3, 2 [symbol] ) (21)

For a k-dimensional dataset of size n, this can be done using merge sort (Cormen et al., 1990, pp. 12-15) in a worst-case running time of O(kn log₂ n). When merge sort is implemented using arrays, it requires linear extra memory and the additional work spent copying to and from the temporary array throughout the algorithm has the effect of slowing down the sort considerably. However, in the example implementation described in section 3.1 below, we use a special implementation of merge sort that employs linked lists and in this implementation no extra memory is required and no copying of data is performed.

2.1.2 SIA: Step 2—Computing Inter-Datapoint Vectors

The second step in SIA is to compute the set

V={ [symbol] D[j]−D[i],i [symbol] |1≦i<j≦|D|} (22)

Note that each member of V is an ordered pair in which the first element is the vector from datapoint D[i] to datapoint D[j] and the second element is the index of the ‘origin’ datapoint, D[i], in D. For the dataset in FIG. 1(a), V contains all the elements below the leading diagonal in Table 1.

We call a table like the one in Table 1 a vector table. Each element in this table is an ordered pair [symbol] v, i [symbol] where i gives the number of the column in which the element occurs and V is the vector from the datapoint at the head of the column in which the element occurs to the datapoint at the head of the row in which the element occurs. For a k-dimensional dataset of size n, this second step of SIA involves computing n(n−1)/2 vector subtractions. It can be accomplished in a worst-case running time of O(kn²).

2.1.3 SIA: Step 3—Sorting the Vectors in the Vector Table

If [symbol] u, i [symbol] and [symbol] v, j [symbol] are any two elements in the set V computed in the second step SIA (Eq.22) then we define that [symbol] u, i [symbol] is less than [symbol] v, j [symbol] , denoted by [symbol] u, i [symbol] < [symbol] v, j [symbol] , if and only if u<v or u=v and i<j.

The third step in SIA is to sort V to give an ordered set V that contains the elements of V in increasing order. For example, the column headed V[i] in Table 2 gives V for the dataset in FIG. 1(a). An examination of Table 1 reveals that the vectors increase as one descends a column and decrease as one goes from left to right along a row. In the implementation of SIA that we describe in section 3.1 below we use a two-dimensional linked list to represent V as a vector table like the one in Table 1 (see FIG. 63). We then use a modified version of merge sort, that exploits the fact that the columns and rows in this vector table are already sorted, to accomplish this third step of the algorithm more rapidly than would be achievable using plain merge sort on the completely unsorted set V. The worst-case running time of this step of the algorithm is O(kn²log₂ n).

2.1.4 SIA: Step 4—Printing Out S(D)

If A is an ordered set of ordered sets then A[i, j] denotes the jth element of the ith element of A. For example, if A= [symbol] [symbol] a,b,c [symbol] , [symbol] d, e [symbol] , [symbol] f [symbol] [symbol] then A[1, 3]=c, A[2, 1]=d and A[3, 1]=f. As pointed out above, the column headed V[i] in Table 2 gives V for the dataset in FIG. 1(a). For each of these ordered pairs, V[i], the datapoint D[V[i, 2]] is printed next to it in the third column in Table 2. For example, V[1]=( [symbol] 0, 1 [symbol] , 3) in Table 2, so V[1, 2]=3 and D[V[1, 2]]= [symbol] 2, 1 [symbol] , the third datapoint in the ordered set D for the dataset shown in FIG. 1(a).

As indicated on the right-hand side of the third column in Table 2, the MTP for a vector v is the set of consecutive datapoints D[V[i, 2]] in the third column that corresponds to the set of consecutive ordered pairs V[i] in the second column for which V[i, 1]=v. The complete set S(D) as defined in Eq.9 can be printed out using the algorithm in FIG. 7. In our pseudocode, block structure is indicated by indentation and the symbol ‘←’ indicates assignment. FIG. 8 shows the output generated by this algorithm for the dataset in FIG. 1 (a).

SIA discovers the set P′(D) of non-empty MTPs defined in Eq.8 and from Table 2 it can easily be seen that SIA accomplishes this simply by sorting the set V defined in Eq.22. It is clear from Table 1 that, for a dataset of size n, the number of elements in V is

$$\frac{n ( n - 1 )}{2} .$$

Therefore, if we use P to denote an MTP in P′(D),

$${\sum }_{P ∈ {𝒫}^{′} ( D )} \vert P \vert = \frac{n ( n - 1 )}{2} .$$

Therefore the total number of vectors that have to be printed when S(D) is printed is

$$\frac{n ( n - 1 )}{2}$$

plus one vector for each MTP in P′(D). Since

$$\vert {𝒫}^{′} ( D ) \vert \leq \frac{n ( n - 1 )}{2} ,$$

the total number of vectors to be printed out is certainly less than or equal to n(n−1). Therefore, for a k-dimensional dataset containing n datapoints, S(D) can be printed out in a worst-case running time of O(kn²).

2.2 The SIATEC Algorithm

When given a multidimensional dataset, D, as input, SIATEC computes T(D) as defined in Eq.12 above. For a k-dimensional dataset containing n datapoints, the worst-case running time of SIATEC is O(kn³) and its worst-case space complexity is O(kn²). The algorithm consists of the following seven steps.

2.2.1 SIATEC: Step 1—Sorting the Dataset

This is exactly the same as Step 1 of SIA as described in section 2.1.1 above.

2.2.2 SIATEC: Step 2—Computing W

The second step in SIATEC is to compute the ordered set of ordered sets

W= [symbol] [symbol] W[1, 1], . . . W[1, |D|] [symbol] , . . . [symbol] W[|D|1], . . . W[|D|, |D|] [symbol] )

where

W[i, j]=D[j]−D[i] (23)

W can be visualized as a vector table like Table 3 (which shows W for the dataset in FIG. 1(a)). Note that each element in W is simply a vector whereas each element in the vector table computed in Step 2 of SIA is an ordered pair (see Table 1). W is used in Step 7 of SIATEC to compute the set of translators for each MTP.

Computing W for a k-dimensional dataset of size n involves computing n² vector subtractions. Each of these vector subtractions involves carrying out k scalar subtractions so the overall worst-case running time of this step is O(kn²).

2.2.3 SIATEC: Step 3—Computing V

The third step of SIATEC is to compute the set V as defined in Eq.22. This is the same set as that computed in Step 2 of SIA. In the example implementation of SIATEC described in section 3.2 below, V is constructed from W so that the inter-datapoint vectors are only computed once. This step can therefore be carried out in a worst-case time complexity of O(n²) and not O(kn²). Table 1 shows V for the dataset in FIG. 1(a).

2.2.4 . SIATEC: Step 4—Sorting V to Produce V

This step is exactly the same as Step 3 of SIA. The second column of Table 2 shows V for the dataset in FIG. 1(a).

2.2.5 SIATEC: Step 5—‘Vectorizing’ the MTPs

V is effectively a sorted representation of S(D) (Eq.9) (see Step 4 of SIA and Table 2). The purpose of SIATEC is to compute T(D) (Eq.12) which is the set that only contains every TEC that is the TEC of an MTP in P′(D) (Eq.8). P′(D) can be obtained from V but it is possible for two or more MTPs in P′(D) to be translationally equivalent. For example, the MTPs in the dataset in FIG. 1(a) for the vectors [symbol] 0, 2 [symbol] , [symbol] 1, −1 [symbol] and [symbol] 1, 1 [symbol] are translationally equivalent (see Table 2 and FIG. 1(c), (c) and (g)). If two patterns are translationally equivalent then they are members of the same TEC. Therefore, if we naïvely compute the TEC of each MTP in P′(D), we run the risk of computing the same TEC more than once which is inefficient. We therefore partition P′(D) into translational equivalence classes and then select just one MTP from each of these classes, discarding the others.

If P is a pattern then let SORT(P) be the function that returns the ordered set that only contains all the datapoints in P sorted into increasing order. If P is an ordered set of datapoints then let VEC(P) be the function that returns the ordered set of vectors

VEC(P)= [symbol] P[2]−P[1], P[3]−P[2], . . . P[|P|]−P[|P|−1] [symbol] (24)

If P₁ and P₂ are two patterns in a dataset, then

VEC(SORT(P₁))=VEC(SORT(P₂))⇄P₁≡ᵣP₂ (25)

We say that VEC(SORT(P)) is the vectorized representation of the pattern P. In the ordered set V computed in Step 4 of SIATEC, each MTP, P, is represented in its sorted form as SORT(P)=P (see Table 2). Therefore, if we want to use Eq.25 to partition P′(D) we first have to compute VEC(P) for each of the sorted MTPs, P, in V. Step 5 of SIATEC is therefore to compute

X={ [symbol] i, VEC(SORT(P)) [symbol] | [symbol] v, P [symbol] ∈S(D)ΛV[i, 1]=vΛ(i=1vV[i−1, 1]≠v)} (26)

If V[i] and V[j] are two distinct elements of V and V[i]<V[j] but V[i, 1]=V[j, 1] (i.e., the vectors in V[i] and V[j] are the same) then V[i, 2]<V[j, 2] which implies that D[V[i, 2]]<D[V[j, 2]]. This means that the datapoints within each MTP in the V representation of S(D) are sorted in increasing order, as can be seen in the output of SIA (FIG. 8) generated by the algorithm in FIG. 7.

X can be efficiently computed directly from V and D using the algorithm in FIG. 9 which exploits the fact that the MTPs in V are already sorted. In FIG. 9, the set X is actually represented as an ordered set X. When the algorithm in FIG. 9 has terminated, the ordered set X only contains all the elements of X (with no duplicates). In FIG. 9, ( ) denotes the empty ordered set.

FIG. 10 shows the state of X for the dataset in FIG. 1(a) at the termination of Step 5 of SIATEC. For a k-dimensional dataset of size n, the worst-case running time of the algorithm in FIG. 9 is O(kn²).

2.2.6 SIATEC: Step 6—Sorting X

Let Q₁ and Q₂ be any two ordered sets in which each element is a k-dimensional vector. We define that Q₁ is less than Q₂, denoted by Q₁<Q₂ if and only if one of the following two conditions is satisfied:

1. |Q₁|<|Q₂|

2. |Q₁|=|Q₂| and there exists an integer 1≦i≦|Q₁| such that Q₁[i]<Q₂[i] and Q₁[j]=Q₂[j] for all 1≦j<i.

(See page 12 for a definition of the expression u<v when u and v are vectors.) In Step 6 of SIATEC, the ordered set X generated by the algorithm in FIG. 9 is sorted to produce the ordered set Y which satisfies the following two conditions:

1. Y only contains all the elements of X.

2. If Y[i] and Y[j] are any two distinct elements of Y then i<j if and only if

Y[i, 2]<Y[j, 2] [symbol] (Y[i, 2]=Y[j, 2]ΛY[i, 1]<Y[j, 1]).

FIG. 11 shows Y for the dataset in FIG. 1(a). For a k-dimensional dataset of size n, this step of the algorithm can be accomplished in a worst-case running time of O(kn²log₂ n) using merge sort.

We know that

MTP(V[Y[i, 1], 1], D)≡_{τ}MTP(V[Y[j, 1], 1], D)⇄Y[i, 2]=Y[j, 2].

So FIG. 11 tells us, for example, that the MTPs for the vectors V[3, 1]= [symbol] 0, 2 [symbol] , V[6, 1]= [symbol] 1, −1 [symbol] and V[11, 1]= [symbol] 1, 1 [symbol] are translationally equivalent since the vectorized representation of each of these patterns is [symbol] [symbol] 1, 0 [symbol] [symbol] . This implies that we only have to compute the TEC of one of these patterns and the other two can be disregarded.

2.2.7 SIATEC: Step 7—Printing Out T′(D)

The final step of SIATEC is to print out T′(D). This can be done using the algorithm in FIG. 12. Recall that each TEC in T′(D) is represented as an ordered pair [symbol] P, T(P, D)\0 [symbol] where P is an MTP and T(P, D) is the set of translators for P in the dataset D (see Eq.13 and discussion on page 16 above). In FIG. 12, each MTP is printed out using the algorithm PRINT_PATTERN called in line 14. This algorithm is given in FIG. 13.

The set of translators for each TEC is printed out using the algorithm PRINT_SET_OF_TRANSLATORS called in line 16 of FIG. 12. This algorithm, which is given in FIG. 14, exploits the fact that

$$T ( \{ D [ i ] \} , D ) = {{⋃}_{j = 1}}^{\vert D \vert} \{ W [ i , j ] \} .$$

That is, the set of translators for a datapoint D[i] is the set that only contains every vector that occurs in the ith column in the vector table computed in Step 2 of SIATEC (see Table 3). In FIG. 12, each MTP is represented as a set of indices, I such that the pattern represented by I is simply {D[i]|i∈I}. The set of translators for the pattern represented by I is therefore

$${⋂}_{i ∈ I} T ( \{ D [ i ] \} , D ) = {⋂}_{i ∈ I} ( {{⋃}_{j = 1}}^{\vert D \vert} \{ W [ i , j ] \} ) . \qquad ( 27 )$$

In other words, the set of translators for a pattern is the set that only contains those vectors that occur in all the columns in the vector table corresponding to the datapoints in the pattern. For example, if D is the dataset in FIG. 1(a), the set of translators for the pattern {a,c}={ [symbol] 1, 1 [symbol] , [symbol] 2, 1 [symbol] } is the set that only contains all the vectors that occur in both the first and third columns in Table 3:

$$T ( \{ ⟨ 1 , 1 ⟩ , ⟨ 2 , 1 ⟩ \} , D ) = \{ ⟨ 0 , 0 ⟩ , ⟨ 0 , 2 ⟩ , ⟨ 1 , 0 ⟩ , ⟨ 1 , 1 ⟩ , ⟨ 1 , 2 ⟩ , ⟨ 2 , 1 ⟩ \} ⋂ \{ ⟨ - 1 , 0 ⟩ , ⟨ - 1 , 2 ⟩ , ⟨ 0 , 0 ⟩ , ⟨ 0 , 1 ⟩ , ⟨ 0 , 2 ⟩ , ⟨ 1 , 1 ⟩ \} = \{ ⟨ 0 , 0 ⟩ , ⟨ 0 , 2 ⟩ , ⟨ 1 , 1 ⟩ \}$$

The algorithm PRINT_SET_OF_TRANSLATORS is an efficient algorithm for computing the expression on the right-hand side of Eq.27.

Using the algorithms in FIGS. 12, 13 and 14, Step 7 can be accomplished in a worst-case running time of O(kn³) for a k-dimensional dataset of size n. FIG. 15 shows the output generated by the algorithm in FIG. 12 for the dataset in FIG. 1(a).

2.3 The SIAME Algorithm

When given a k-dimensional query pattern, P, and a k-dimensional dataset, D, as input, SIAME computes M′(P, D) as defined in Eq.18 above. For a k-dimensional query pattern containing m datapoints and a k-dimensional dataset containing n datapoints, the worst-case running time of SIAME is O(kmn log₂(mn)) and its worst-case space complexity is O(kmn). The algorithm consists of the following 5 steps.

2.3.1 SIAME: Step 1—Computing the Set of Inter-Datapoint Vectors

The first step in SIAME is very similar to Step 2 of SIA (see section 2.1.2): given a query pattern P and a dataset D, the set

V_{SIAME}={ [symbol] d−p, p [symbol] |d∈DΛp∈P} (28)

is computed. For example, for the query pattern in FIG. 3(a) and the dataset in FIG. 3(b), V_{SIAME} m would contain all and only the elements in Table 4. Note that each element in V_{SIAME} is an ordered pair of vectors. In an implementation (such as the one described in section 3.4 below) the second vector in each of these ordered pairs would probably be represented by a pointer to the datapoint in the representation of P or by an index to an element of an array storing P.

For a k-dimensional pattern of size m and a k-dimensional dataset of size n, this step can be accomplished in a worst-case running time of O(kmn) using O(kmn) space.

2.3.2 SIAME: Step 2—Sorting the Inter-Datapoint Vectors

In our description of Step 6 of SIATEC in section 2.2.6 above we defined the concept of ‘less than’ when applied to ordered sets of vectors. The second step in SIAME is similar to Step 3 of SIA (see section 2.1.3): the set V_{SIAME} computed in Step 1 of SIAME is sorted to give an ordered set V_{SIAME} that contains the elements of V_{SIAME} sorted into increasing order. Again, as can be seen in Table 4, each column in the table is already sorted. This fact can be used to advantage if V_{SIAME} is represented as a two-dimensional linked list and merge sort is used to perform the sort (see section 3.4 below). This step of the algorithm can be accomplished in a worst-case running time of O(kmn log₂(mn)). Alternatively, if hashing is used, the step can be accomplished in an expected time of O(kmn). FIG. 16 shows V_{SIAME} for the query pattern in FIG. 3(a) and the dataset in FIG. 3(b).

2.3.3 SIAME: Step 3—Computing the Size of Each Set in M(P, D)

It is very useful if the matches found by SIAME are listed so that the best matches occur first. To achieve this, it is necessary to compute the size of each element of M(P, D). Therefore, in this third step of SIAME, the set

N={ [symbol] |M|, i [symbol] | [symbol] v, M [symbol] ∈M′(P, D)ΛV_{SIAME}[i, 1]=vΛ(i=1 [symbol] V_{SIAME}[i−1, 1]≠v)} (29)

is computed. This can be done directly from V_{SIAME} using the algorithm in FIG. 17 which returns an ordered set, N, that only contains every element of N exactly once. FIG. 18 shows N for the pattern in FIG. 3(a) and the dataset in FIG. 3(b). The worst-case running time of the algorithm in FIG. 17 is O(kmn).

2.3.4 SIAME: Step 4—Sorting N

The fourth step of SIAME is to sort the vectors in N to produce a new ordered set, N′ that only contains all the vectors in N sorted into decreasing order. This can be achieved in a worst-case running time of O(mn log₂(mn)). Note that this step is not dependent on the cardinality of the datapoints in the pattern and dataset. FIG. 19 shows N′ for the pattern in FIG. 3(a) and the dataset in FIG. 3(b).

2.3.5 SIAME: Step 5—Computing M′(P, D)

Finally, M′(P, D), expressed as an ordered set, M, in which the best matches occur first, can be computed directly from N′ and V_{SIAME} using the algorithm shown in FIG. 20.

The worst-case running time of this algorithm is O(kmn). FIG. 21 shows M for the pattern in FIG. 3(a) and the dataset in FIG. 3(b).

2.4 The COSIATEC Algorithm

When given a multidimensional dataset D as input, COSIATEC uses SIATEC to compute a compressed representation of D in the form of an ordered set of TECs satisfying the conditions described on page 19 above.

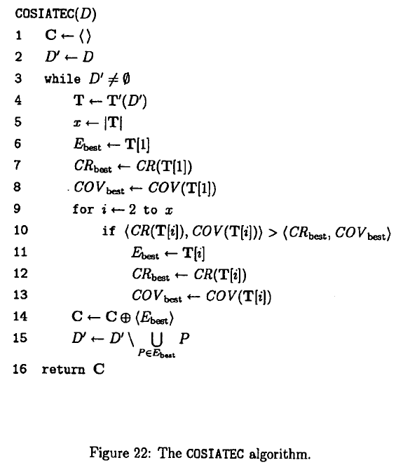

FIG. 22 shows a simple (but inefficient) version of the COSIATEC algorithm. The ordered set variable C is used to store the compressed representation and it is initalised to equal the empty ordered set in line 1. The variable D′ is used to hold the current value of Dₖ as defined on page 19 above. This variable is initialised to equal D in line 2.

On each iteration of the ‘while’ loop (lines 3-15), SIATEC is first used to compute T′(D′) (line 4). Then, in lines 5-13, an element E_{best} of ε_{best}(D′) (see page 19) is computed which is appended to C (line 14). In line 15, D′ has all datapoints removed from it that are elements of patterns in E_{best}. The while loop terminates when D′ is empty (line 3).

In line 4, the function T′(D′) uses SIATEC to compute an ordered set containing the elements of T′(D′) arranged in some arbitrary order. The functions COV(E) and CR(E) are as defined in Eqs.19 and 20 above.

### 3 EXAMPLE IMPLEMENTATIONS OF THE ALGORITHMS

In this section, efficient implementations of the SIA, SIATEC, SIAME and COSIATEC algorithms will be described.

### 3.1 Example Implementation of SIA

In this section we describe an efficient implementation of the SIA algorithm described in section 2.1 above.

3.1.1 . The SIA Procedure

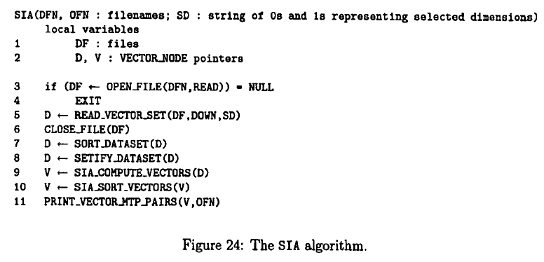

FIG. 24 gives pseudocode for an efficient implementation of SIA. In this algorithm, the dataset to be analysed is stored in a file whose name is given in the parameter DFN. The output of the algorithm is written to a file whose name is given in the parameter OFN.

The third parameter to the algorithm, SD, is either NULL or a string of 0s and 1s indicating the orthogonal projection of the dataset to be analysed. For example, if the dataset stored in the file whose name is DFN is a 5-dimensional dataset but the user only wishes to analyse the 2-dimensional projection of this dataset onto the plane defined by the first and third dimensions, then SD would be set to “10100”. If SD is NULL, all the dimensions are considered.

In line 3 of the SIA implementation in FIG. 24, an attempt is made to open the file whose name is DFN. The function OPEN_FILE returns NULL and the program exits (line 4) if this attempt is unsuccessful.

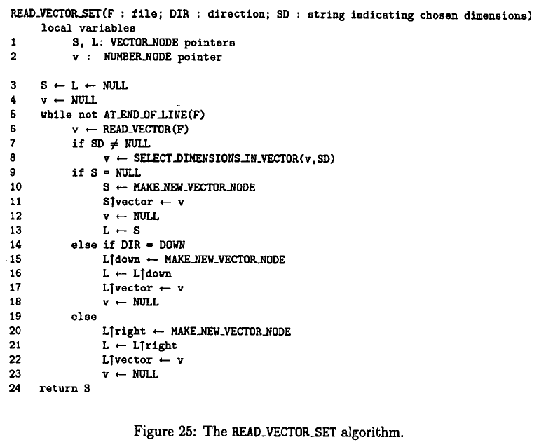

If the file DFN exists, then the dataset is read into memory in line 5 using the READ_VECTOR_SET function which is defined in FIG. 25 and discussed further in section 3.1.2 below. The file containing the input dataset is then closed in line 6.

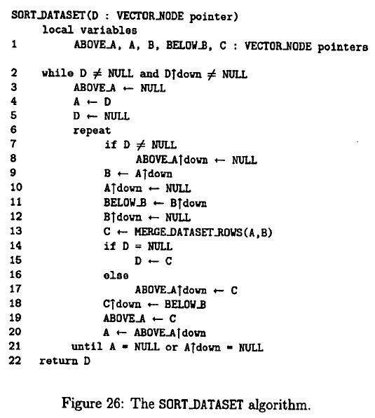

In line 7, the dataset is sorted using the SORT_DATASET algorithm which is defined in FIG. 26 and discussed further in section 3.1.3 below.

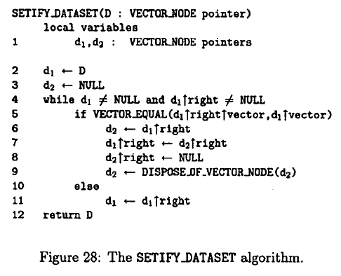

If the SD parameter is used to select an orthogonal projection of the dataset, then it is possible for two or more datapoints in the dataset stored in DF to be projected onto the same datapoint in the chosen projection of this dataset. If this happens, then D may contain duplicate datapoints. These are removed in line 8 of the SIA implementation (see FIG. 24) using the SETIFY_DATASET algorithm which is defined in FIG. 28 and discussed further in section 3.1.4 below.

This accomplishes Step 1 of the SIA algorithm as described in section 2.1.1 above.

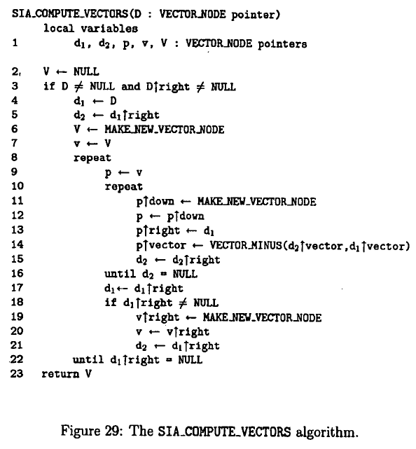

The function SIA_COMPUTE_VECTORS, defined in FIG. 29 and called in line 9 of the SIA implementation in FIG. 24, accomplishes Step 2 of the SIA algorithm as described in section 2.1.2 above. SIA_COMPUTE_VECTORS is discussed further in section 3.1.5 below.

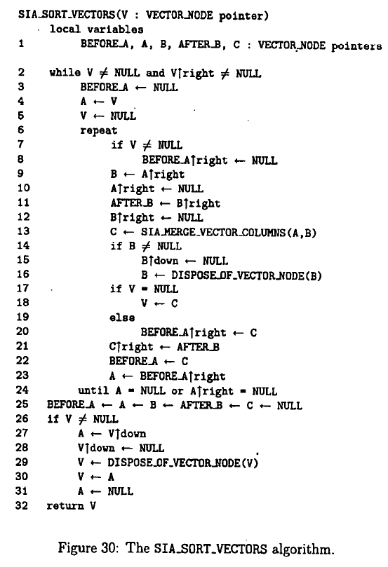

The function SIA_SORT_VECTORS, defined in FIG. 30 and called in line 10 of the SIA implementation in FIG. 24, accomplishes Step 3 of the SIA algorithm as described in section 2.1.3 above. SIA_SORT_VECTORS is discussed further in section 3.1.6 below.

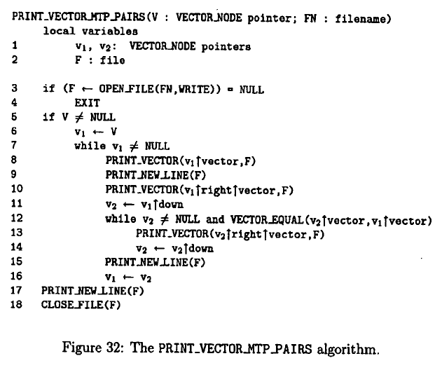

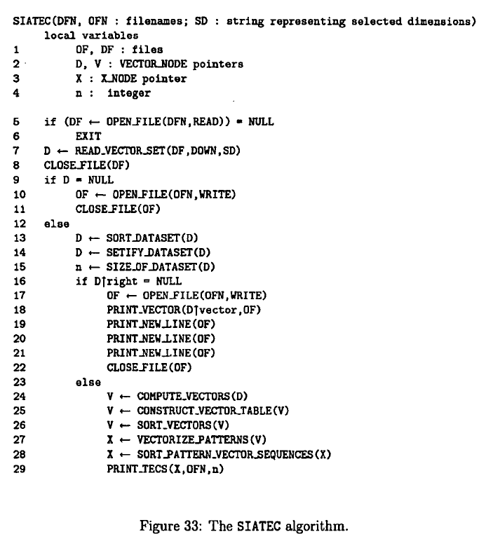

Finally, Step 4 of the SIA algorithm, described in section 2.1.4 above, is carried out using the PRINT_VECTOR_MTP_PAIRS procedure which is defined in FIG. 32 and called in line 11 of the SIA implementation in FIG. 24. PRINT_VECTOR_MTP_PAIRS is an implementation of the algorithm in FIG. 7. It is discussed further in section 3.1.7 below.

For a k-dimensional dataset containing n datapoints, the worst-case running time of this implementation of the SIA algorithm is O(kn²log₂ n) (this is the running time of SIA_SORT_VECTORS called in line 10 of the implementation). The worst-case space complexity is O(kn²).

3.1.2 The READ_VECTOR_SET Function

FIG. 25 gives pseudocode for the READ_VECTOR_SET function which is called in line 5 of the SIA implementation given in FIG. 24. This algorithm reads a list of vectors from a file and stores the list in memory as a linked list, returning a pointer (S in FIG. 25) to the head of this list.

READ_VECTOR_SET takes three parameters: F is a text file containing the list of vectors to be read; DIR determines the type of linked list used to store the vectors (see below); and SD is either NULL or a string of 0s and 1s is indicating a specific orthogonal projection of the vector set to be read (see section 3.1.1 above).

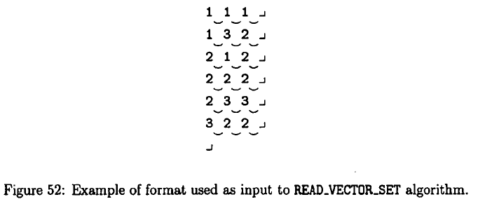

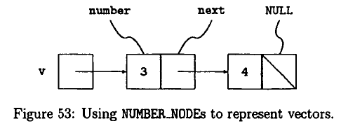

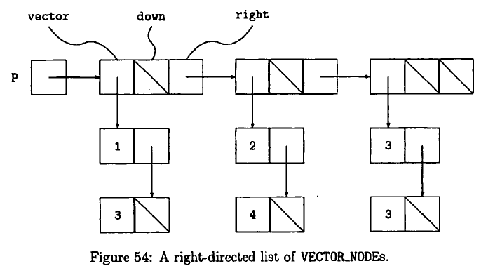

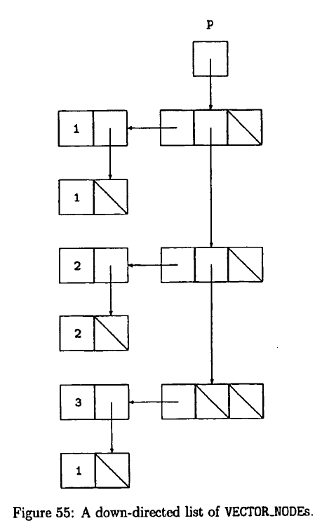

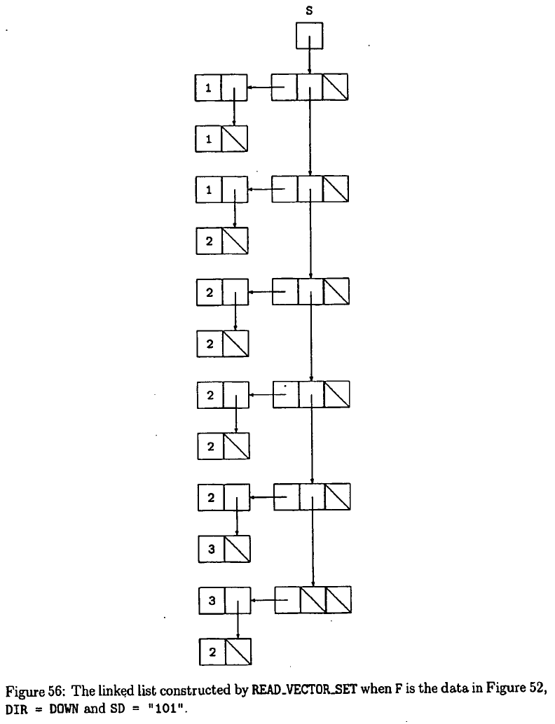

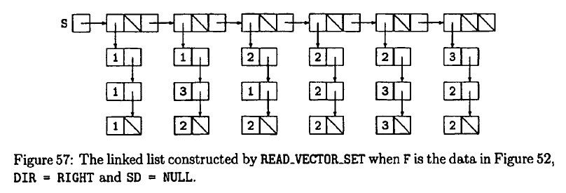

It is assumed that the collection of vectors to be read from the file F is represented as a list with one vector per line, the list being terminated by an empty line. Each vector is represented as a list of numerical values, each one followed by a single space character and terminated by an end-of-line character. For example, FIG. 52 shows how the ordered vector set

[symbol]

[symbol]

1, 1, 1 [symbol] , [symbol] 1, 3, 2 [symbol] , [symbol] 2, 1, 2 [symbol] , [symbol] 2, 2, 2 [symbol] , [symbol] 2, 3, 3 [symbol] , [symbol] 3, 2, 2

[symbol]

[symbol]

would be represented in the input file F. In FIG. 52, ‘ [symbol] ’ represents a space character and ‘ [symbol] ’ represents an end-of-line character.

The linked list constructed by READ_VECTOR_SET uses two types of node: NUMBER_NODEs and VECTOR_NODEs.

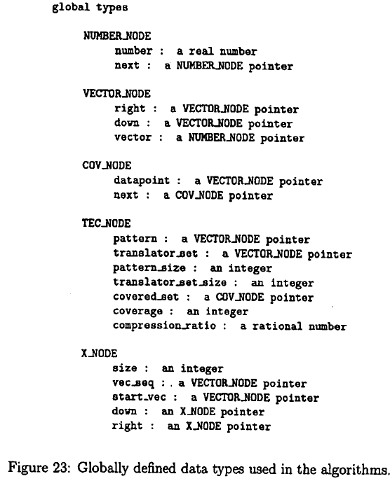

NUMBER_NODEs are used to construct linked lists that represent vectors. Each NUMBER_NODE has two fields, one called number and the other called next (see definition in FIG. 23). The number field of a NUMBER_NODE is used to hold a numerical value. The next field is a NUMBER_NODE pointer used to point to the node that holds the next element in the vector. A NUMBER_NODE can be represented diagrammatically as a rectangular box divided into two cells (see FIG. 53). The left-hand cell represents the number field and the right-hand cell represents the next field. A cell with a diagonal line drawn across it represents a pointer whose value is NULL. The pointer v in FIG. 53 heads a linked list of NUMBER_NODEs that represents the vector [symbol] 3, 4 [symbol] .

VECTOR_NODEs are used to construct linked lists that represent vector sets, such as patterns and datasets. Each VECTOR_NODE has three fields. a NUMBER_NODE pointer called vector and two VECTOR_NODE pointers, one called down and the other called right (see definition in FIG. 23). A VECTOR_NODE can be represented diagrammatically as a rectangular box divided into three cells (see FIG. 54). The left-hand cell represents the vector field, the middle cell represents the down field and the right-hand cell represents the right field. The field called vector is always used to head a linked list of NUMBER_NODEs representing a vector. The right field is used to point to the next VECTOR_NODE in a right-directed list such as the one shown in FIG. 54. The down field is used to point to the next VECTOR_NODE in a down-directed list such as the one shown in FIG. 55. The linked list in FIG. 54 could be used to represent the ordered set of vectors [symbol] [symbol] 1, 3 [symbol] , [symbol] 2, 4 [symbol] , [symbol] 3, 3 [symbol] [symbol] or the vector set { [symbol] 1, 3 [symbol] , [symbol] 2, 4 [symbol] , [symbol] 3, 3 [symbol] }. The linked list in FIG. 55 could be used to represent the ordered vector set [symbol] [symbol] 1, 1 [symbol] , [symbol] 2, 2 [symbol] , [symbol] 3, 1 [symbol] [symbol] or the vector set { [symbol] 1, 1 [symbol] , [symbol] 2, 2 [symbol] , [symbol] 3, 1 [symbol] }. The fact that each VECTOR_NODE has both a down and a right field allows for a linked list of VECTOR_NODEs to be efficiently sorted using an implementation of merge sort that converts an unsorted down-directed list into a sorted right-directed list (see the algorithms SORT_DATASET (defined in FIG. 26 and discussed in section 3.1.3) and SIA_SORT_VECTORS (defined in FIG. 30 and discussed in section 3.1.6)).

If the DIR parameter of the READ_VECTOR_SET function (FIG. 25) has the value DOWN, the vector set read by the algorithm is stored as a down-directed list of VECTOR_NODEs, otherwise the vector set is stored as a right-directed list. If F contains the data in FIG. 52, then FIG. 56 shows the linked list returned by the call

READ_VECTOR_SET(F, DOWN, “101”)

and FIG. 57 shows the linked list returned by

READ_VECTOR_SET (F, RIGHT, NULL)

In our pseudocode, the symbol ‘↑’ denotes pointer dereferencing: that is, the expression ‘x↑y’ denotes the field called y in the data structure pointed to by x.

The function AT_END_OF_LINE(F) used in line 5 of READ_VECTOR_SET (see FIG. 25) returns TRUE if the next character to be read from F is an end-of-line character or an end-of-file character. The function is used to determine whether or not all the vectors in a list have been read.

The function READ_VECTOR called in line 6 of READ_VECTOR_SET reads a vector from a file and returns a linked list of NUMBER_NODEs representing the vector (as in FIG. 53).

The function SELECT_DIMENSIONS_IN_VECTOR(v,SD) called in line 8 of READ_VECTOR_SET uses SD to remove those elements of v that are not required in the chosen orthogonal projection of the vector set.

The function MAKE_NEW_VECTOR_NODE called in lines 10, 15 and 20 of READ_VECTOR_SET creates a new VECTOR_NODE and sets all its fields to NULL.

3.1.3 The SORT_DATASET Function

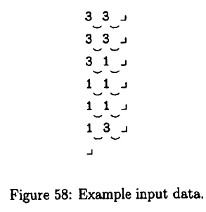

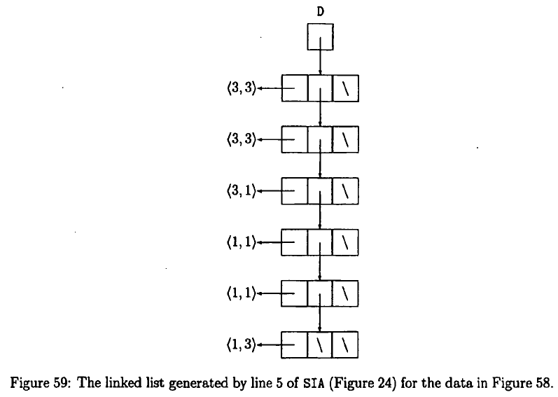

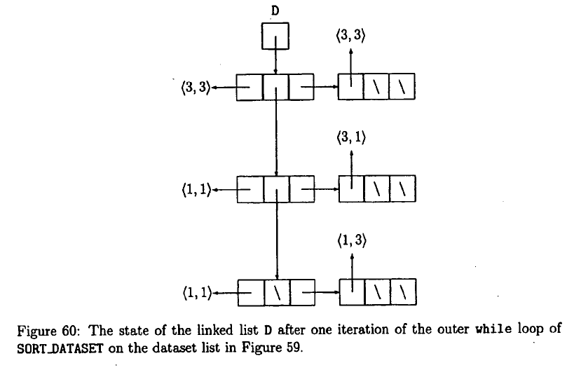

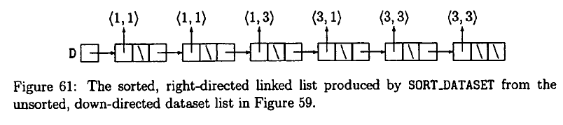

FIG. 26 gives pseudocode for the SORT_DATASET algorithm called in line 7 of the SIA algorithm implementation given in FIG. 24. In FIG. 24, the call to READ_VECTOR_SET in line 5 stores the orthogonal projection of the dataset to be analysed as an unsorted, down-directed list of VECTOR_NODEs. For example, in FIG. 24, if DFN is the name of a file containing the data in FIG. 58 then the call to READ_VECTOR_SET in line 5 would return the linked list in FIG. 59.

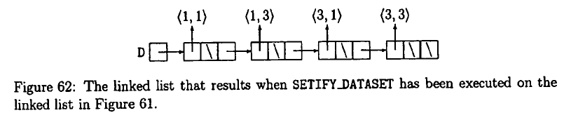

SORT_DATASET is a version of merge sort that converts the unsorted down-directed list of VECTOR_NODEs generated by the call to READ_VECTOR_SET in line 5 of SIA into a sorted, right-directed list. On the first iteration of the outer while loop (lines 2-21 in FIG. 26), SORT_DATASET scans the down-directed list of unsorted datapoints, merging each pair of consecutive datapoints into a single, sorted, right-directed list. For example, FIG. 59 shows the unsorted, down-directed list generated by line 5 of SIA (see FIG. 24) for the data in FIG. 58 and FIG. 60 shows the state of the linked list D after one iteration of the outer while loop of SORT_DATASET has been completed on the dataset list shown in FIG. 59. On subsequent iterations, each pair of adjacent right-directed lists is merged into a single list and the process continues until the whole list has been merged into a single, sorted, right-directed list. FIG. 61 shows the right-directed list produced by SORT_DATASET from the down-directed list shown in FIG. 59.

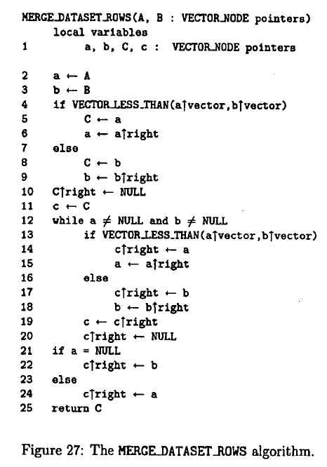

The merging process is carried out by the MERGE_DATASET_ROWS algorithm which is called in line 13 of SORT_DATASET and defined in FIG. 27.

In lines 4 and 13 of the MERGE_DATASET_ROWS algorithm in FIG. 27, the function VECTOR_LESS_THAN(v₁, v₂) is used to compare two vectors represented as NUMBER_NODE lists headed by the pointers v₁ and v₂. The function VECTOR_LESS_THAN returns TRUE if and only if the vector represented by the NUMBER_NODE list headed by v₁ is less than that represented by the list headed by v₂.

3.1.4 The SETIFY_DATASET Function

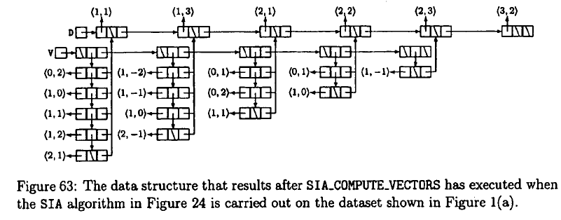

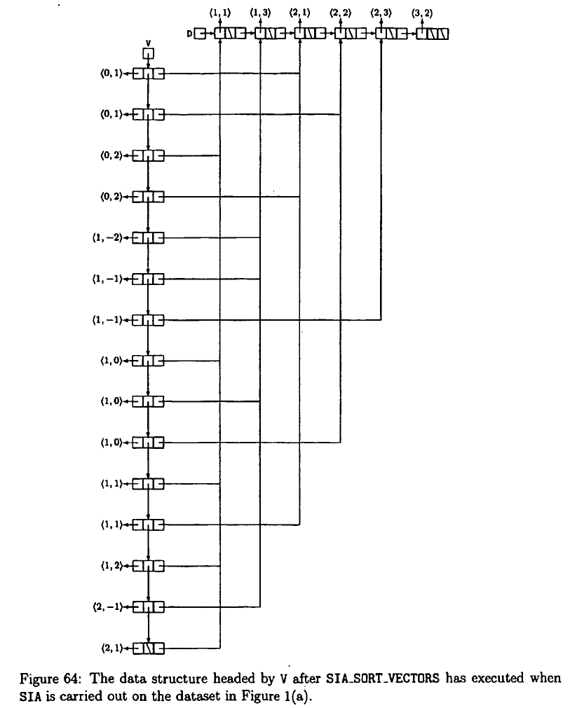

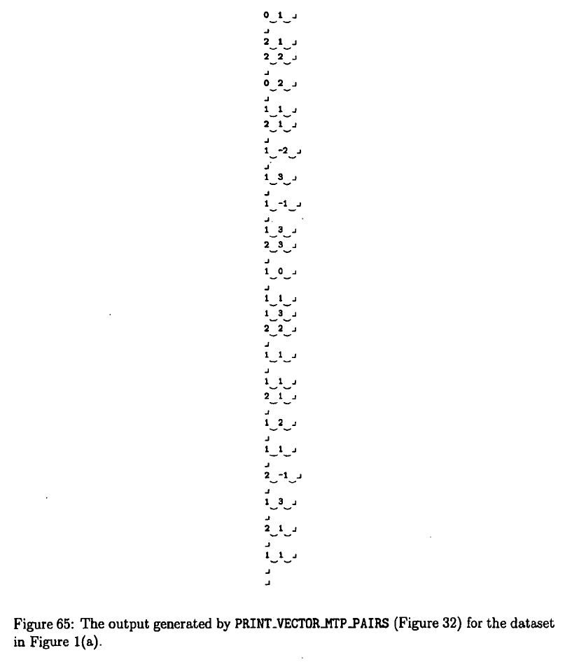

FIG. 28 gives pseudocode for the SETIFY_DATASET algorithm called in line 8 of the SIA implementation in FIG. 24. SETIFY_DATASET removes duplicate datapoints from the sorted right-directed list generated by SORT_DATASET. For example, if SETIFY_DATASET is given the linked list shown in FIG. 61 as input, it returns the linked list shown in FIG. 62. The call to SORT_DATASET in line 7 of the SIA implementation and the call to SETIFY_DATASET in line 8 together accomplish Step 1 of the SIA algorithm described in section 2.1 above.

The VECTOR_EQUAL function used in line 5 of SETIFY_DATASET in FIG. 28 takes two NUMBER_NODE pointer arguments, each heading a list of NUMBER_NODEs representing a vector, and returns TRUE if and only if the two vectors are equal.

The DISPOSE_OF_VECTOR_NODE function used in line 9 of SETIFY_DATASET destroys the linked multi-list of VECTOR_NODEs headed by its argument and deallocates the memory used by this list.

3.1.5 The SIA_COMPUTE_VECTORS Function

The function SIA_COMPUTE_VECTORS, defined in FIG. 29 and called in line 9 of SIA (see FIG. 24), accomplishes Step 2 of the SIA algorithm as described in section 2.1.2 above.

FIG. 63 shows the data structure that results after SIA_COMPUTE_VECTORS has executed when the SIA implementation in FIG. 24 is carried out on the dataset shown in FIG. 1(a). The resulting data structure is a representation of the vector table shown in Table 1.

The VECTOR_MINUS(v₁, v₂) function called in line 14 of SIA_COMPUTE_VECTORS (see FIG. 29) takes two NUMBER_NODE pointer arguments, each pointing to a linked-list representing a vector, and subtracts the vector pointed to by v₂ from the vector pointed to by v₁, returning a pointer to the linked list representing the result.

3.1.6 The SIA_SORT_VECTORS Function

The function SIA_SORT_VECTORS, defined in FIG. 30 and called in line 10 of the SIA implementation in FIG. 24, accomplishes Step 3 of the SIA algorithm as described in section 2.1.3 above.

The call to SIA_SORT_VECTORS in line 10 of the SIA implementation is the most expensive step in the program, requiring O(kn² log₂ n) time in the worst case.

SIA_SORT_VECTORS takes the data structure headed by V returned by SIA_COMPUTE_VECTORS (see FIG. 63) and uses a modified version of merge sort to generate a single down-directed list representing the ordered set V defined in section 2.1.3 above.

As can be seen in FIG. 63, the structure headed by V consists of a right-directed list of VECTOR_NODEs from each of which ‘hangs’ a down-directed list of nodes. Each of these ‘hanging’ down-directed lists represents a column in Table 1. Within each of these down-directed lists the vectors are already sorted into increasing order. SIA_SORT_VECTORS exploits this fact to accomplish its task more efficiently.

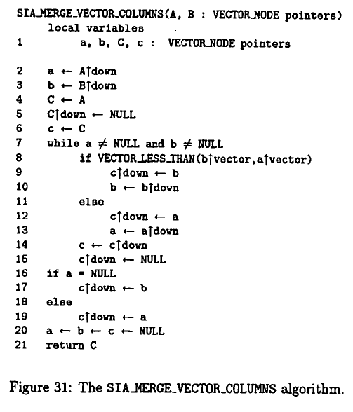

In SIA_SORT_VECTORS, the merging process is carried out using the SIA_MERGE_VECTOR_COLUMNS function which is called in line 13 and defined in FIG. 31.

FIG. 64 shows the data structure that results after the call to SIA_SORT_VECTORS in line 10 of the implementation of SIA in FIG. 24 has executed when this implementation is run on the dataset in FIG. 1(a). This data structure represents the second column in Table 2.

3.1.7 The PRINT_VECTOR_MTP_PAIRS Function

Step 4 of the SIA algorithm, described in section 2.1.4 above, is carried out in this implementation using the PRINT_VECTOR_MTP_PAIRS algorithm which is defined in FIG. 32 and called in line 11 of the SIA procedure in FIG. 24.

PRINT_VECTOR_MTP_PAIRS is an implementation of the algorithm in FIG. 7 except that the format of the output is simpler than that produced by the algorithm in FIG. 7.

In the output of PRINT_VECTOR_MTP_PAIRS, each [symbol] vector, MTP [symbol] pair is represented as a pair of consecutive vector lists in the same format as that used for input to SIA (see FIG. 52). That is, for each [symbol] vector, MTP [symbol] pair, the vector is first printed out on a single line, then there is an empty line, then the MTP is printed out as a list of vectors, each vector being printed on a separate line, and the MTP being terminated by an empty line. The end of the file is also signalled by an empty line. This means that every odd-numbered vector list in the output file represents the vector of a (vector,MTP) pair and every even-numbered vector list represents the MTP in such a pair.

FIG. 65 shows the output generated by the PRINT_VECTOR_MTP_PAIRS algorithm for the dataset in FIG. 1(a). This provides the same information as FIG. 8 except that it is presented in a different (and less complicated) format.

In lines 8, 10 and 13 of the PRINT_VECTOR_MTP_PAIRS procedure in FIG. 32, PRINT_VECTOR is used to print the vectors. PRINT_VECTOR takes two arguments: the first is a pointer to a NUMBER_NODE list representing a vector and the second is the file to which the vector is to be written.

PRINT_VECTOR_MTP_PAIRS also uses the procedure PRINT_NEW_LINE(F) (lines 9, 15 and 17) to print an end-of-line character to the file stream F.

### 3.2 Example Implementation of SIATEC

In this section we describe an efficient implementation of the SIATEC algorithm described in section 2.2 above.

3.2.1 The SIATEC Procedure

FIG. 33 gives pseudocode for an efficient implementation of SIATEC.

Like the SIA implementation in FIG. 24, the SIATEC procedure in FIG. 33 takes three arguments: DFN is the name of the file containing the dataset to be analysed; OFN is the name of the file to which the output is written; and SD is a string of 1s and 0s indicating the orthogonal projection of the dataset to be analysed (see discussion in section 3.1.1 above).

If the file whose name is DFN exists, then the call to READ_VECTOR_SET in line 7 of FIG. 33 reads the dataset into memory and stores it in an unsorted, down-directed list of VECTOR_NODEs. This is exactly the same as the task carried out in line 5 of the SIA implementation in FIG. 24 (see discussion of READ_VECTOR_SET in section 3.1.2 above).

If the dataset is empty (line 9, FIG. 33), then an empty output file is created and the algorithm terminates.

If the dataset is not empty, then it is sorted in line 13 using the SORT_DATASET function and ‘setified’ in line 14 using the SETIFY_DATASET function. These functions are defined in FIGS. 26 and 28 and were described above in sections 3.1.3 and 3.1.4.

This accomplishes Step 1 of the SIATEC algorithm as described in section 2.2.1 above.

The PRINT_SET_OF_TRANSLATORS algorithm defined in FIG. 14 and used in Step 7 of the SIATEC algorithm described in section 2.2.7 above, uses a knowledge of the size of the dataset (stored in the variable n) to increase efficiency (see line 2 in FIG. 14). Therefore, in line 15 of the implementation of SIATEC given in FIG. 33, the size of the dataset is computed using a function SIZE_OF_DATASET which simply scans the sorted, right-directed list of VECTOR_NODEs generated by SETIFY_DATASET in line 14 and counts the number of datapoints in the list.

If a dataset D contains only one point, D={d}, then the only TEC in D is {{d}}. If the dataset given as input to the procedure in FIG. 33 contains only one datapoint, then D↑right=NULL in line 16 and an output file is generated containing the single datapoint in the dataset.

If the dataset contains more than one datapoint, lines 24-29 in FIG. 33 are executed.

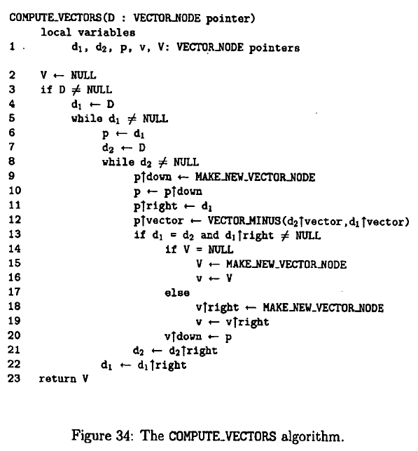

The function COMPUTE_VECTORS called in line 24 of FIG. 33 and defined in FIG. 34 accomplishes Step 2 of the SIATEC algorithm described in section 2.2.2 above. The COMPUTE_VECTORS function is discussed further in section 3.2.2 below.

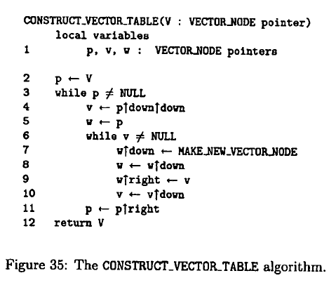

The function CONSTRUCT_VECTOR_TABLE called in line 25 of FIG. 33 and defined in FIG. 35 accomplishes Step 3 of the SIATEC algorithm described in section 2.2.3 above. It is discussed further in section 3.2.3 below.

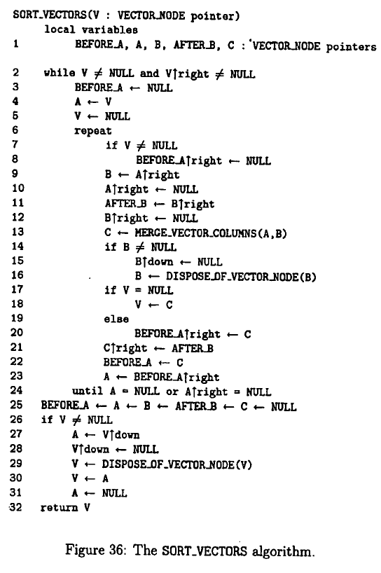

The function SORT_VECTORS called in line 26 of FIG. 33 and defined in FIG. 36 accomplishes Step 4 of the SIATEC algorithm described in section 2.2.4 above. SORT_VECTORS is discussed further in section 3.2.4 below.

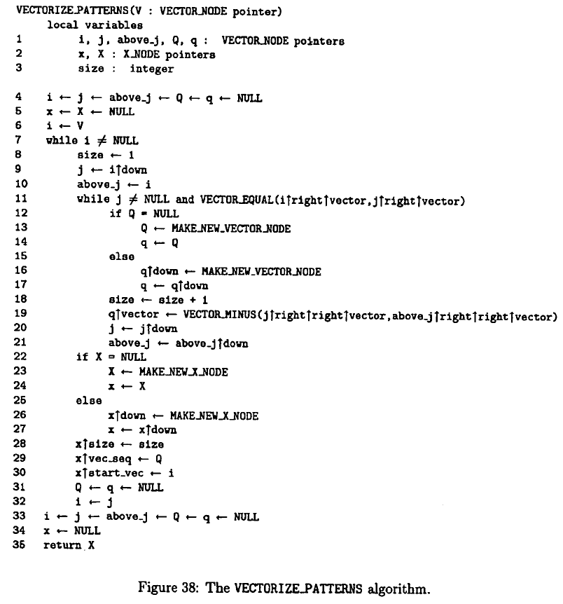

The function VECTORIZE_PATTERNS called in line 27 of FIG. 33 and defined in FIG. 38 accomplishes Step 5 of the SIATEC algorithm described in section 2.2.5 above. VECTORIZE_PATTERNS is an implementation of the algorithm in FIG. 9. It is discussed further in section 3.2.5 below.

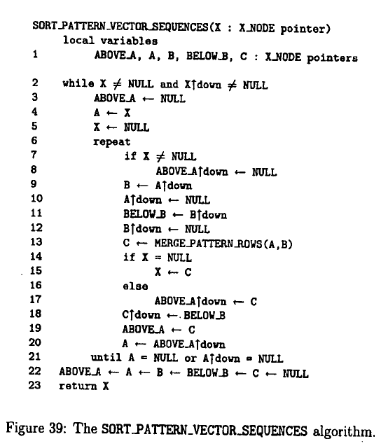

The function SORT_PATTERN_VECTOR_SEQUENCES called in line 28 of FIG. 33 and defined in FIG. 39 accomplishes Step 6 of the SIATEC algorithm described in section 2.2.6 above. It is discussed further in section 3.2.6 below.

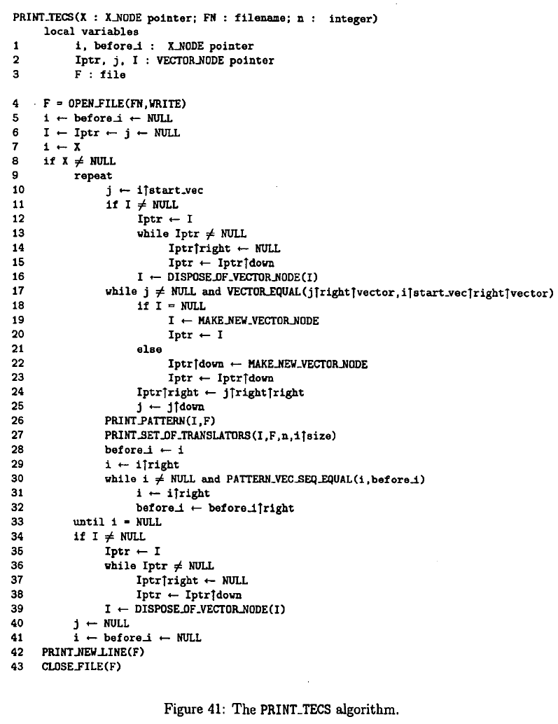

Finally, the PRINT_TECS algorithm called in line 29 of FIG. 33 and defined in FIG. 41 accomplishes Step 7 of the SIATEC algorithm described in section 2.2.7 above. PRINT_TECS is an implementation of the algorithm in FIG. 12. It is discussed further in section 3.2.7 below.

For a k-dimensional dataset containing n datapoints, the worst-case running time of this implementation of the SIATEC algorithm is O(kn³). This is the running time of PRINT_TECS which is the most expensive step in the implementation. The worst-case space complexity is O(kn²). This is kept to a minimum by avoiding the need for storing the TECs in memory at any point—PRINT_TECS computes the TECs as it prints them out.

3.2.2 The COMPUTE_VECTORS Algorithm

The function COMPUTE_VECTORS called in line 24 of FIG. 33 and defined in FIG. 34 accomplishes Step 2 of the SIATEC algorithm described in section 2.2.2 above.

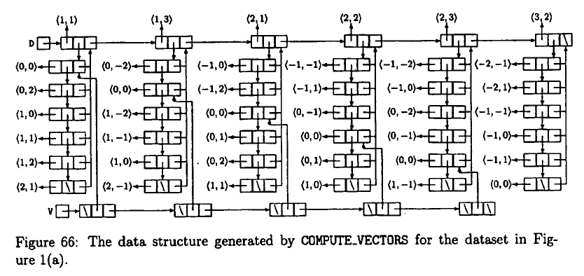

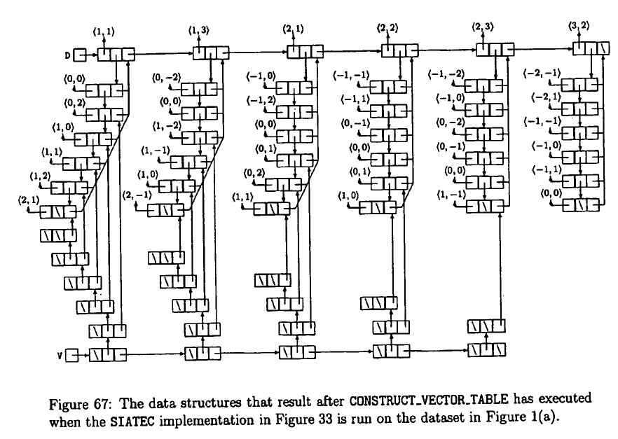

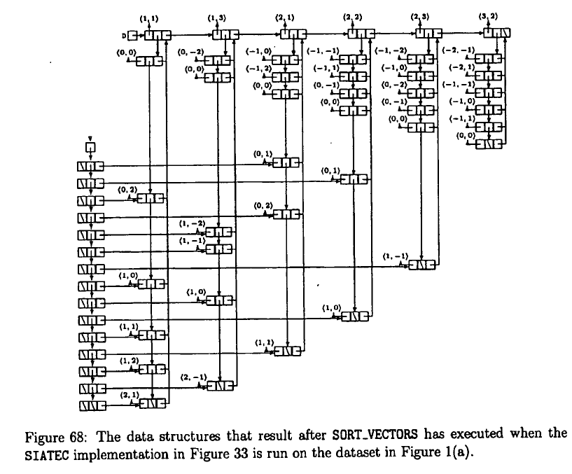

COMPUTE_VECTORS constructs a two-dimensional linked-list structure that represents the ordered set of ordered sets, W, defined in Eq.23. FIG. 66 shows the data structure that results after COMPUTE_VECTORS has executed when the SIATEC algorithm in FIG. 33 is run on the dataset in FIG. 1(a). The data structure in FIG. 66 is a representation of Table 3.

3.2.3 The CONSTRUCT_VECTOR_TABLE Function

The function CONSTRUCT_VECTOR_TABLE called in line 25 of FIG. 33 and defined in FIG. 35 accomplishes Step 3 of the SIATEC algorithm described in section 2.2.3 above.

FIG. 67 shows the data structures that result after CONSTRUCT_VECTOR_TABLE has executed when the SIATEC implementation in FIG. 33 is run on the dataset in FIG. 1(a). That is, CONSTRUCT_VECTOR_TABLE converts the data structure in FIG. 66 into the data structure in FIG. 67. The two-dimensional list headed by V in FIG. 67 is a representation of Table 1 while the pointer D is used to access the multi-List that represents Table 3.

3.2.4 The SORT_VECTORS Algorithm

The function SORT_VECTORS called in line 26 of FIG. 33 is defined in FIG. 36 and accomplishes Step 4 of the SIATEC algorithm described in section 2.2.4 above.

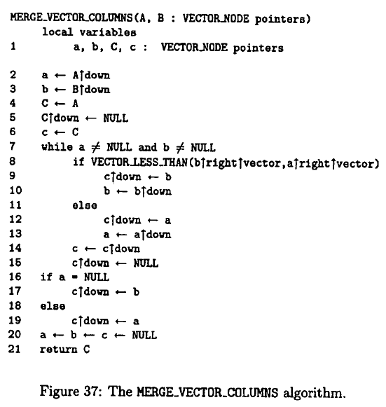

Like SIA_SORT_VECTORS in FIG. 30, SORT_VECTORS is a version of merge sort. In fact, the only difference between SORT_VECTORS and SIA_SORT_VECTORS is that in line 13 of SORT_VECTORS, the merging process is performed by the MERGE_VECTOR_COLUMNS function defined in FIG. 37 whereas in line 13 of SIA_SORT_VECTORS, this process is performed using the function SIA_MERGE_VECTOR_COLUMNS defined in FIG. 31.

Similarly, the only difference between SIA_MERGE_VECTOR_COLUMNS (FIG. 31) and MERGE_VECTOR_COLUMNS (FIG. 37) occurs in line 8 where the arguments to the VECTOR_LESS_THAN function are b↑right↑vector and a↑right↑vector in MERGE_VECTOR_COLUMNS and b↑vector and a↑vector in SIA_MERGE_VECTOR_COLUMNS.

The reason for this difference can be seen by comparing the multi-list headed by V in FIG. 67 with that headed by V in FIG. 63. In both cases, the multi-list data structure accessed via V represents Table 1. In both cases, each down-directed list of nodes that ‘hangs’ off the down field of a node in the right-directed list headed by V represents a column in Table 1, that is, the set of inter-datapoint vectors originating on a particular datapoint. In FIG. 63, the vector field of each node in these down-directed ‘column’ lists points directly at an inter-datapoint vector. However, in FIG. 67, the vector field of each of these nodes is empty and instead the right field is used to point to the node in the multi-list headed by D that holds the required inter-datapoint vector.

This extra level of indirection is necessary in SIATEC because the structure of the multi-list representing Table 3 must be preserved as it is used to compute TECs by the PRINT_TECS function (defined in FIG. 41 and called in line 29 of the SIATEC implementation in FIG. 33).

FIG. 68 shows the state of the data structures headed by D and V after SORT_VECTORS has executed when the implementation of SIATEC in FIG. 33 is run on the dataset in FIG. 1(a).

3.2.5 The VECTORIZE_PATTERNS Algorithm

The function VECTORIZE_PATTERNS called in line 27 of FIG. 33 and defined in FIG. 38 accomplishes Step 5 of the SIATEC algorithm described in section 2.2.5 above. VECTORIZE_PATTERNS is an implementation of the algorithm in FIG. 9.

VECTORIZE_PATTERNS uses the data structure accessed by V in the SIATEC procedure (see FIG. 33) to compute a linked-list representation of the ordered set X in FIG. 9 which is itself an ordered set representation of the set X defined in Eq.26.

The representation of X generated by VECTORIZE_PATTERNS is a linked list of X_NODEs headed by the variable X in FIG. 38. The X_NODE data type is defined in FIG. 23. Each X_NODE in the list headed by X computed by VECTORIZE_PATTERNS represents one of the ordered pairs [symbol] i, Q [symbol] in X (see line 10 in FIG. 9). Q in FIG. 9 is modelled in VECTORIZE_PATTERS as a linked list of VECTOR_NODEs which is first headed by the variable Q (see, e.g., line 12 in FIG. 38) but then stored in the vec_seq field of its X_NODE (line 29, FIG. 38). The first element of each [symbol] i, Q [symbol] ordered pair in X in FIG. 9 is represented in an X_NODE by the field start_vec which is used to point to the appropriate VECTOR_NODE in the list headed by V (see line 30 in FIG. 38). The size field of an X_NODE representing an ordered pair [symbol] i, Q [symbol] in X is used to store the size of the pattern for which Q is the vectorized representation (see line 28 in FIG. 38). The down and right fields of an X_NODE are used to construct two different types of linked list. The unsorted down-directed list of X_NODEs generated by VECTORIZE_PATTERNS is converted into a sorted right-directed list by the function SORT_PATTERN_VECTOR_SEQUENCES which is called in line 28 of FIG. 33 and defined in FIG. 39.

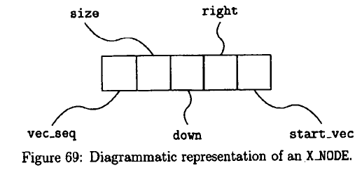

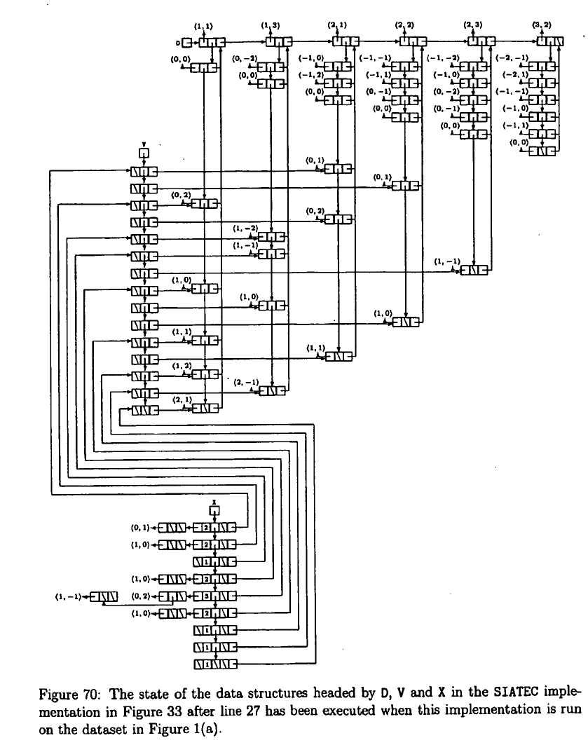

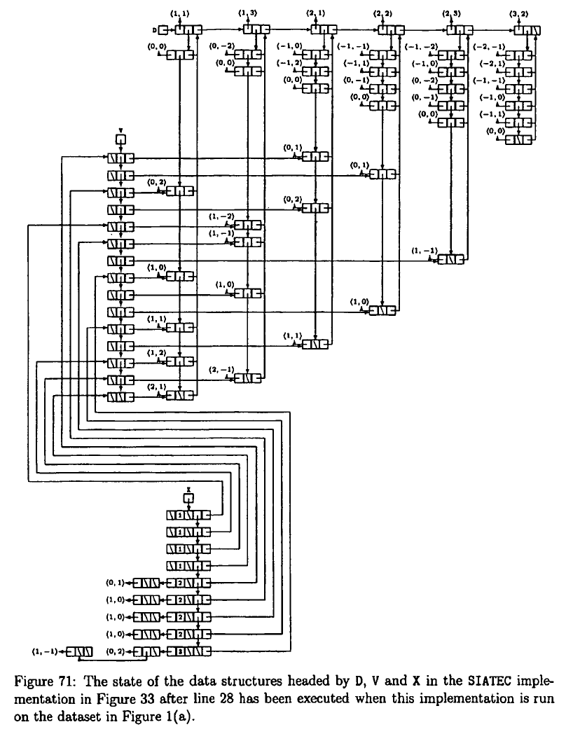

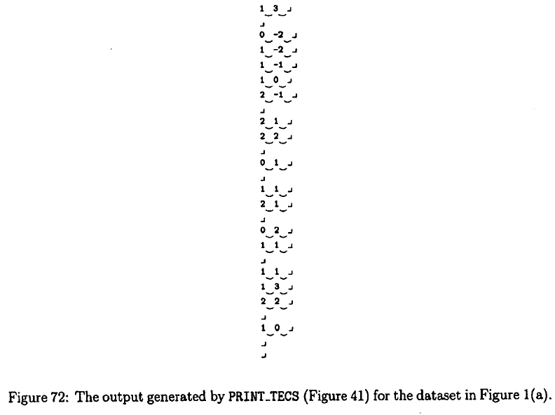

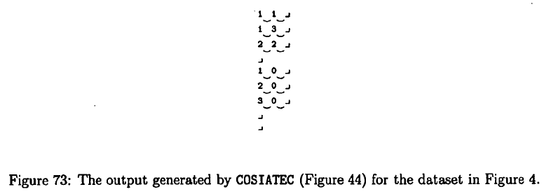

An X_NODE can be represented diagrammatically as a rectangular box divided into 5 cells as shown in FIG. 69. As shown in this figure, the cells represent, from left to right, the vec_seq, size, down, right and start_vec fields.

The MAKE_NEW_NODE function called in lines 23 and 26 of VECTORIZE_PATTERNS simply creates a new X_NODE, sets its size field to zero and all the other fields to NULL.

FIG. 70 shows the state of the data structures headed by D, V and X in the implementation of SIATEC in FIG. 33 after line 27 has been executed when this implementation is run on the dataset in FIG. 1(a).

3.2.6 The SORT_PATTERN_VECTOR_SEQUENCES Algorithm

The function SORT_PATTERN_VECTOR_SEQUENCES called in line 28 of the SIATEC implementation in FIG. 33 and defined in FIG. 39 accomplishes Step 6 of the SIATEC algorithm described in section 2.2.6 above.

Like SORT_DATASET (FIG. 26) and SORT_VECTORS (FIG. 36), SORT_PATTERN_VECTOR_SEQUENCES is an implementation of merge sort. The function VECTORIZE_PATTERNS called in line 27 of the SIATEC implementation in FIG. 33 returns an unsorted, down-directed list of X_NODEs that represents the ordered set X computed by the algorithm in FIG. 9 (see, for example, FIG. 70). The call to SORT_PATTERN_VECTOR_SEQUENCES in line 28 of the SIATEC implementation (FIG. 33) converts this unsorted down-directed list into a sorted, right-directed list of X_NODEs that represents the ordered set Y computed in Step 6 of the SIATEC algorithm described in section 2.2.6 above.

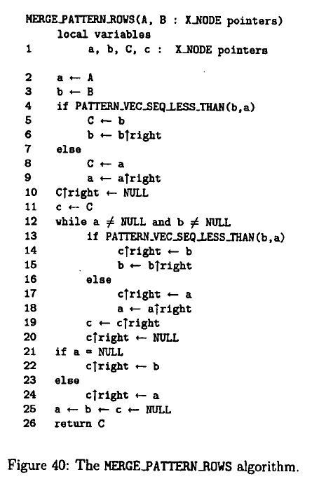

In SORT_PATTERN_VECTOR_SEQUENCES (FIG. 39), the merging process is performed by the function MERGE_PATTERN_ROWS called in line 13 and defined in FIG. 40. The function PATTERN_VEC_SEQ_LESS_THAN called in line 13 of MERGE_PATTERN_ROWS, implements the definition of ‘less than’ when applied to ordered sets of vectors defined in section 2.2.6 above.

FIG. 71 shows the state of the data structures headed by D, V and X in the SIATEC implementation in FIG. 33 after line 28 has been executed when this implementation is run on the dataset in FIG. 1(a).

3.2.7 The PRINT_TECS Algorithm

The PRINT_TECS algorithm called in line 29 of the SIATEC implementation in FIG. 33 and defined in FIG. 41, accomplishes Step 7 of the SIATEC algorithm described in section 2.2.7 above.

PRINT_TECS is an implementation of the algorithm in FIG. 12. In PRINT_TECS, the variable X heads the right-directed list of X_NODEs representing the ordered set Y computed in Step 6 of the SIATEC algorithm described in section 2.2.6 above.

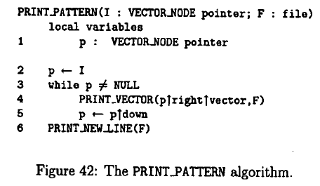

The PRINT_PATTERN procedure called in line 26 of PRINT_TECS and defined in FIG. 42 is an implementation of the algorithm in FIG. 13.

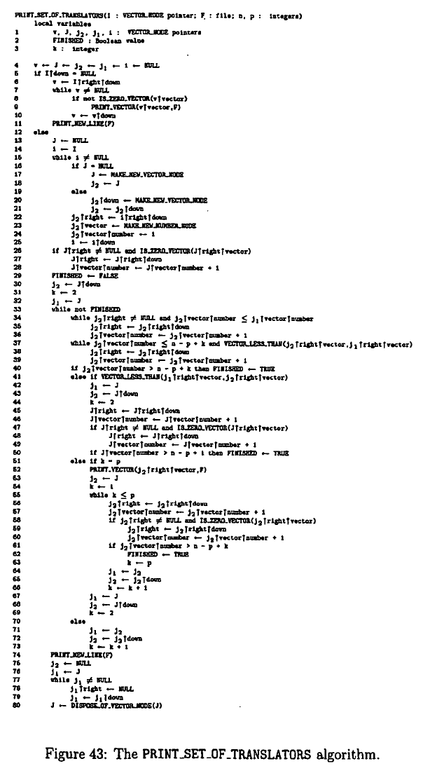

The PRINT_SET_OF_TRANSLATORS procedure called in line 27 of PRINT_TECS and defined in FIG. 43 is an implementation of the algorithm in FIG. 14. The IS_ZERO_VECTOR function called in lines 8, 26, 47 and 58 of the PRINT_SET_OF_TRANSLATORS procedure in FIG. 43 returns TRUE if and only if its argument is equal to the zero vector (i.e., a linked list of NUMBER_NODEs in which every number is 0).

The PATTERN_VEC_SEQ_EQUAL function called in line 30 of PRINT_TECS (see FIG. 41) takes two X_NODE pointer arguments and returns TRUE if and only if the ordered vector sets represented by the vec_seq fields of the two X_NODEs are equal.

FIG. 72 shows the output generated by PRINT_TECS for the dataset in FIG. 1(a).

This represents the set of TECs shown in FIG. 15. Recall that each TEC in the output of SIATEC is represented as an ordered pair [symbol] P, T(P, D)\0 [symbol] where P is a non-empty MTP and T(P, D) is the set of translators for P. For each of the [symbol] pattern,translator set [symbol] pairs generated by SIATEC, the PRINT_TECS procedure in FIG. 41 first prints out the pattern as a list of vectors, each vector on its own line and the whole list terminated by an empty line (see FIG. 72). It then prints an empty line before printing out the translator set, also as a list of vectors each vector on its own line and the set terminated by an empty line. Thus, in the output shown in FIG. 72, the odd-numbered vector lists represent patterns and each even-numbered vector list represents the set of translators for the pattern that precedes it.

### 3.3 Example Implementation of COSIATEC

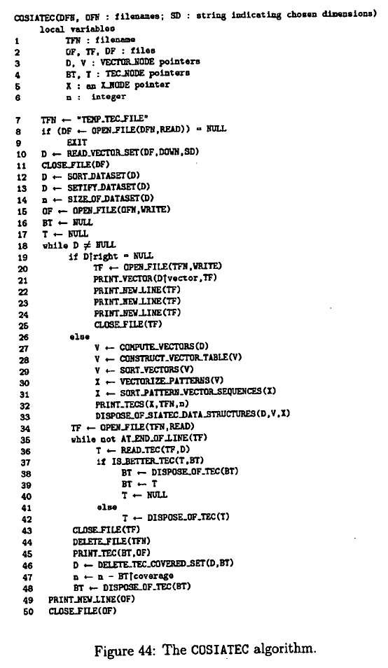

FIG. 44 shows an efficient implementation of the COSIATEC algorithm in FIG. 22.

Like the SIA and SIATEC implementations described above, the COSIATEC implementation in FIG. 44 takes three arguments: DFN is the name of the file containing the dataset to be analysed; OFN is the name of the file to which the output will be written; and SD is a string of 1s and 0s representing the orthogonal projection of the dataset to be analysed (see section 3.1.1 above).

If the file called DFN exists then it is opened (line 8, FIG. 44) and the dataset is read (line 10) using READ_VECTOR_SET (defined in FIG. 25). The dataset is then sorted (line 12) and setified (line 13) using the SORT_DATASET (FIG. 26) and SETIFY_DATASET (FIG. 28) functions already described. The size of the dataset is then computed (line 14) using the SIZE_OF_DATASET function described in section 3.2.1 above.

The while loop that begins at line 18 in FIG. 44 implements the while loop beginning at line 3 in FIG. 22. Lines 19-32 in FIG. 44 are essentially the same as lines 16-29 of the SIATEC implementation in FIG. 33. On each iteration of the while loop, this code from SIATEC is used to compute T′(D) for the dataset stored in the right-directed list of VECTOR_NODEs headed by the variable D. This set of TECs is then stored in a temporary file whose name is kept in TFN (line 32, FIG. 44).

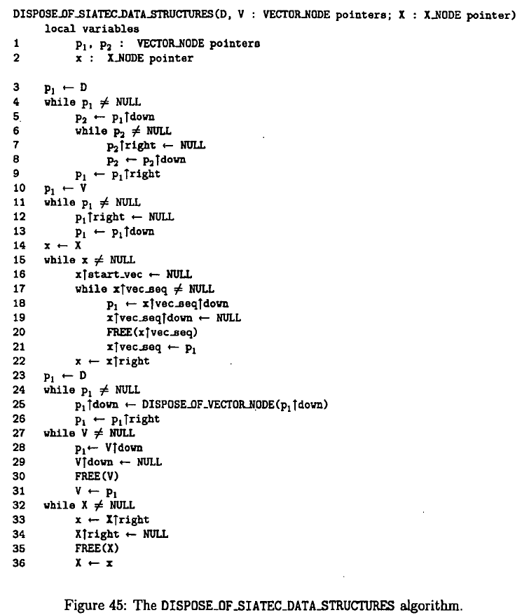

To prevent memory leakage, the data structures headed by V and X are deallocated in line 33 of FIG. 44 using the function DISPOSE_OF_SIATEC_DATA_STRUCTURES defined in FIG. 45.

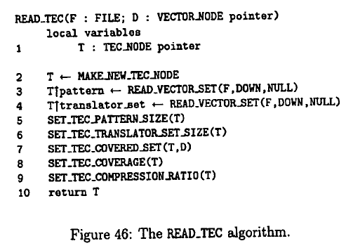

The temporary TEC file TF is then opened (line 34, FIG. 44) and each TEC in this file is read into memory in turn using the READ_TEC function called in line 36 of FIG. 44 and defined in FIG. 46. This function will be discussed further in section 3.3.1 below.

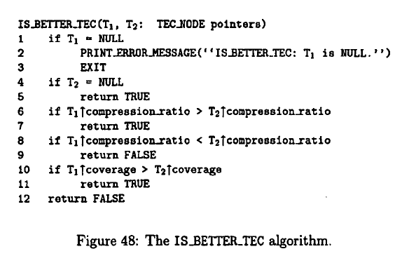

The function IS_BETTER_TEC called in line 37 of the COSIATEC implementation in FIG. 44 is an implementation of line 10 in FIG. 22. It is defined in FIG. 48 and discussed further in section 3.3.3 below.

If IS_BETTER_TEC returns TRUE then the newly read TEC is stored as the best TEC so far and the previously best TEC is deleted using the function DISPOSE_OF_TEC called in line 38 of FIG. 44.

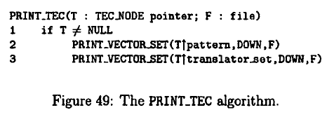

Once all the TECs have been read from the temporary TEC file, TF, the while loop beginning at line 35 terminates. and the best TEC is stored in the variable BT. The file TF is then closed and deleted (lines 43 and 44 of FIG. 44). The best TEC is then written to the output file OF in line 45 using the PRINT_TEC procedure defined in FIG. 49 and described further in section 3.3.4 below. Line 45 in FIG. 44 is an implementation of line 14 in FIG. 22.

Finally, line 15 of the COSIATEC algorithm in FIG. 22 is implemented in line 46 of the implementation in FIG. 44 using the DELETE_TEC_COVERED_SET function defined in FIG. 51.

In line 47 of FIG. 44, the variable n is recalculated. so that it once more stores the number of remaining datapoints in the list headed by D. The coverage field of a TEC_NODE stores the coverage of the TEC as defined in Eq.19 above.

3.3.1 The READ_TEC Function

In line 36 of FIG. 44, the function READ_TEC, defined in FIG. 46, is used to read each TEC from the temporary TEC file. Each TEC is stored in a TEC_NODE data structure as defined in FIG. 23.

In line 2 of READ_TEC, a new TEC_NODE is created, the numerical fields are set to zero and the pointer fields are set to NULL. The pointer T is set to point to the new node. If [symbol] P, T(P, D)\0 [symbol] is the TEC that is to be read, then in line 3 of READ_TEC, the pattern P is represented as a down-directed list of VECTOR_NODEs pointed to by the pattern field of T. The set of non-trivial translators, T(P, D)\0, is then, in line 4 of READ_TEC, represented as a down-directed list of VECTOR_NODEs pointed to by the translator_set field of T. The size of P (that is τ↑pattern) is then computed in line 5 and stored in the field τ↑pattern_size. In line 6, the size of T(P, D)\0 is computed and stored in the field τ↑translator_set_size. In line 7 of READ_TEC, the set

$${⋃}_{v ∈ T ( P , D )} τ ( P , υ )$$

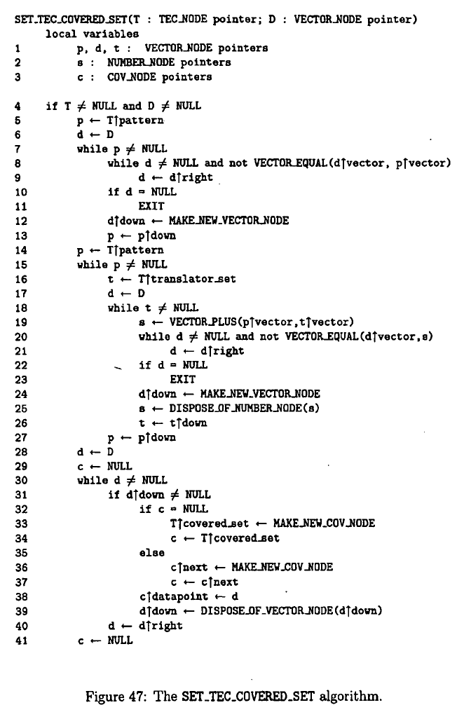

is computed and stored in the covered_set field of T. This is done using the SET_TEC_COVERED_SET function defined in FIG. 47 and described further in section 3.3.2 below. This allows the coverage of the TEC (see Eq.19) to be computed in line 8 of READ_TEC and stored in the coverage field of T.

Finally the compression ratio of the TEC as defined in Eq.20 is computed in line 9 of READ_TEC and stored in the compression_ratio field of T.

3.3.2 The SET_TEC_COVERED_SET Function

If the TEC_NODE pointer T represents the TEC [symbol] P, T(P, D)\0 [symbol] then the function SET_TEC_COVERED_SET(T), called in line 7 of the READ_TEC function and defined in FIG. 47, computes the set

$${⋃}_{v ∈ T ( P , D )} τ ( P , υ )$$

and stores this set as a linked list of COV_NODEs, headed by the pointer T↑covered_set.

Each COV_NODE has two fields as defined in FIG. 23: the datapoint field is a VECTOR_NODE pointer used to point at a VECTOR_NODE representing a datapoint in the list headed by D; the next field simply points at the next COV_NODE in the linked list. In this way, a linked list of COV_NODEs can be used to represent a subset of the dataset.

The function VECTOR_PLUS called in line 19 of SET_TEC_COVERED_SET simply returns a NUMBER_NODE list representing the vector that results from adding the two vectors represented by its arguments.

The DISPOSE_OF_NUMBER_NODE function called in line 25 of the SET_TEC_COVERED_SET function in FIG. 47 destroys and deallocates the list of NUMBER_NODEs headed by its argument.

The MAKE_NEW_COV_NODE function called in lines 33 and 36 of SET_TEC_COVERED_SET makes a new COV_NODE and sets both of its fields to NULL.

3.3.3 The IS_BETTER_TEC Function

The function IS_BETTER_TEC called in line 37 of the COSIATEC implementation in FIG. 44 is an implementation of line 10 in FIG. 22. It is defined in FIG. 48.

The PRINT_ERROR_MESSAGE procedure called in line 2 of IS_BETTER_TEC simply prints out its argument to the standard output.

As can be seen in FIG. 48, the IS_BETTER_TEC function uses the compression_ratio and coverage fields of its argument TEC_NODEs, T₁ and T₂, to determine whether or not T₁ would be a preferable choice to T₂ for use in the compressed representation generated by COSIATEC.

3.3.4 The PRINT_TEC Function

The PRINT_TEC function called in line 45 of the COSIATEC implementation in FIG. 44 is used to output the ‘best TEC’ for the current state of the dataset to the output file.

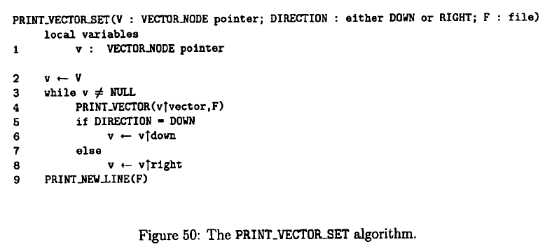

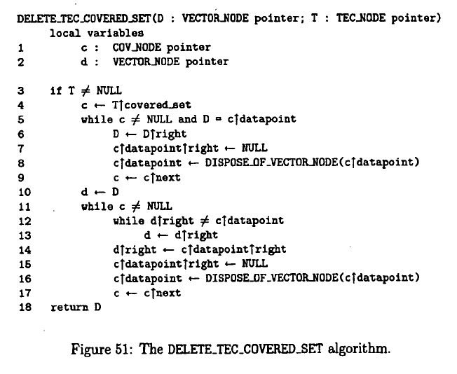

PRINT_TEC, which is defined in FIG. 49, uses the procedure PRINT_VECTOR_SET defined in FIG. 50 to print out first the pattern and then the set of translators for the TEC.

FIG. 73 shows the output generated by the COSIATEC implementation in FIG. 44 for the dataset in FIG. 4. The format of the output for the COSIATEC function in FIG. 44 is the same as that generated by the SIATEC implementation in FIG. 33.

### 3.4 Example Implementations of SIAME

Two versions of the SIAME algorithm will now be described: for a pattern of size m and a dataset of size n, the first version has an average running time of O(nm); the second has a worst-case running time of O(nm log(nm)).

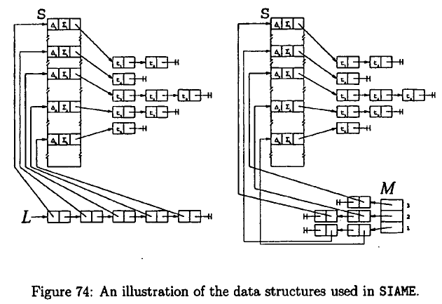

In FIG. 74, we illustrate the working of SIAME. Given the points tᵢ of the pattern T and dⱼ of dataset D, the aim is to generate the structure M in the bottom right-hand corner. The first version does this with the aid of an array, S, and a linked list, L; the second version needs only the former. M stores the (vector, point-set) pairs in decreasing order of point-set size.

Let us briefly describe the structures before introducing the pseudo-codes. Each element of the array S contains three fields: ptr, Δ, and Σ. Field “ptr” is a pointer to a linked list of tᵢs that are translatable by a vector \overline{v} which, itself, is stored in field Δ. Σ stores the number of tᵢs translatable by \overline{v}, that is, the size of the subset of T represented by this list.

For the first version of SIAME, it is crucial that the (used) nodes in the array S are reachable in constant time. Hence it maintains a temporary linked list L, in which each element contains two pointer fields. Field “ptr” points to a used element in S, while “next” points to the next element in the list. M is an array of pointers, each of which is pointing to a linked list of the same form as that of L.

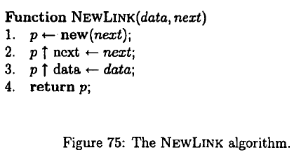

Let us first introduce a function that shall be called by both versions of SIAME. We denote by square brackets ([ ]) and an upwards-arrow (↑) array indexing and element pointing, respectively. The function NEWLINK (FIG. 75) takes two parameters: the first is either a datapoint or a pointer; the second is a pointer to a linked list. NEWLINK allocates a new node of the element type pointed to by the latter parameter, and adds this created node as the first element of the linked list. The value of the first parameter is stored in the “data” field of the created node. Note that because the newly created node is put at the very beginning of the list, NEWLINK is executed in constant time.

3.4.1 Finding Patterns in O(mn) Time on Average.

In order to execute SIAME in O(mn) time, we need to choose the right element of S in constant time. A simple solution allocates space for the whole possible value range along each dimension and uses array indirection based on the translation vectors, \overline{v}=d−t, which select members of the SIAME output set. This works in constant time, and so is efficient in this respect. The input dataset D for SIAME, however, may be very large in quite ordinary applications. Furthermore, the data may be quite sparse. Therefore, not only is there a potential for the data structures to be generated to become of excessive size, but it is very likely that a large proportion of the space that the program attempts to allocate for them is never actually needed. So we have to balance the strictures of space against the time required to access the data.

In this first version we do so by using a hash function F that hashes the translation vectors into an array of size O(nmk) where m and n are, respectively, the size of the pattern to be searched for and the size of the dataset being searched, and k is the number of dimensions represented in the input data. We use closed hashing (Weiss, 1993), in other words, only identical values are hashed to the same location of the array. To make the hashing work in an expected constant time, the frequency of collisions should be kept low. A collision occurs when two different input values p₁ and p₂, p₁≠P₂, have an identical hashed value, F(p₁)=F(p₂). This is possible with a hashing array of size approximately twice the number of the items to be hashed (Weiss, 1993). Moreover, a secondary hashing procedure (or a resolution function) is needed. For more details on this, see Weiss (1993).

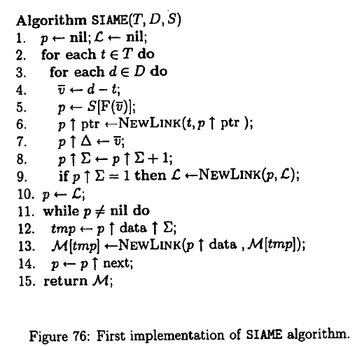

Given T, D, and S as input, the first version of SIAME is as shown in FIG. 76. In the nested loops at lines 2-9, SIAME operates by comparing each point t in the query pattern with each point d in the dataset and uses the main structure S to store the (vector, point-set) pairs. The hashing function F (including also the resolution function) is used at line 5 to find the index in S corresponding to \overline{v}. After a new node storing the value t is added to the linked list associated with the vector, then the fields of S, at the element F(\overline{v}), are updated. If the current vector, \overline{v}, has not been met before, a new node is added to the head of the linked list L (line 9) and the “data” field of this new node is set to point to S[F(\overline{v})].

Having executed these nested loops, the main structure S contains the (vector, point-set) pair information, and the list elements of L point to the nodes of S corresponding to the vectors that were found to be present in the input data. The length of the list L is O(mn).

The next phase is to go through the (vector point-set) pairs (lines 11-14) and sort them according to their size counts. The pairs are stored in the structure M of size O(mn). To give an example, see FIG. 74, where Σ₃=3; Σ₁=Σ₄=2; and Σ₂=Σ₅=1).

The total expected time complexity of this first version of SIAME is O(mn). This is because the execution of line 5 takes a constant time on average. In the worst case, however, it takes O(mn) time and, therefore, the worst case time complexity for this version is O((mn)²). The remaining lines within the nested for loops are executable in constant time. Thus, the execution of lines 2-9 takes O(mn) on average, while the loop at lines 11-14 is clearly executable in O(mn) time, even in the worst case.

3.4.2 Finding Patterns in O(mn log(mn)) Time in the Worst Case.

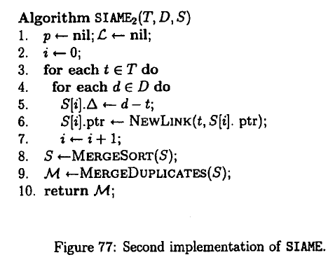

In the former implementation, S comprised an array of size 2 nm for each dimension of the vectors. It is in our interest to reduce that still further for our databases may be very large. Our second version needs an array of size nm. On average it may be slower than the former version, but in the worst case it needs O(mn log(mn)) time, where m is usually very small. The second version of SIAME is as shown in FIG. 77.

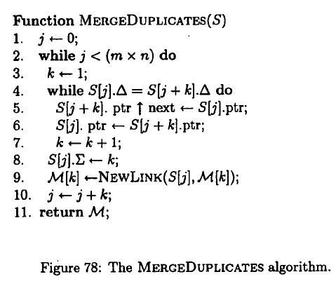

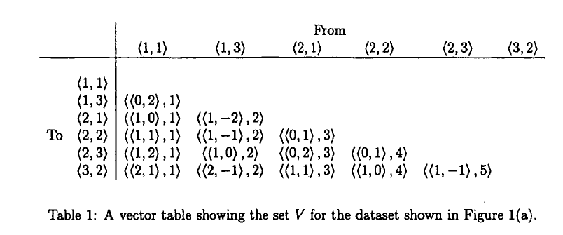

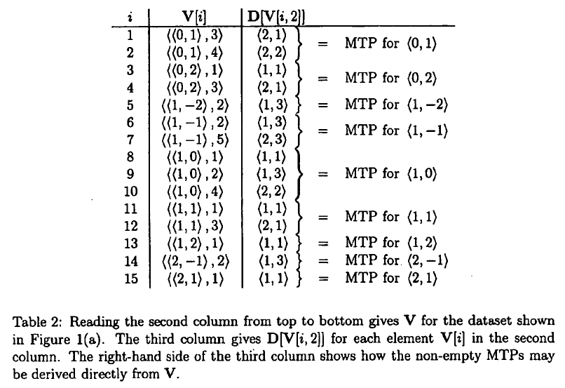

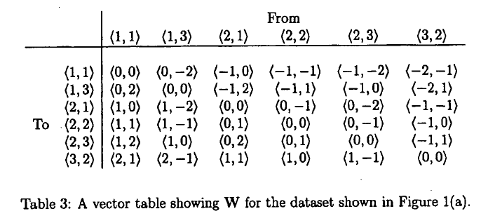

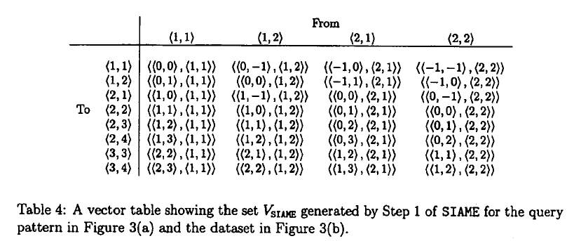

This version of SIAME first stores all the vectors with the associated tᵢ in S. Then S is sorted with respect to the vectors by the conventional merge sort. Although Quicksort is faster on average than merge sort, the worst-case time-complexity of Quicksort is O(n²) which is worse than the worst-case running time of merge sort. Another reason for preferring merge sort here is because the implementation could be based on linked lists, which would make merge sort an appropriate choice. Finally, the function MERGEDUPLICATES in FIG. 78 is executed. If the vectors at the consecutive indices in S are identical, MERGEDUPLICATES merges them; all these query pattern datapoints are collected at the location, say j, where the vector first occurred in S. Then the Σ field is updated, and an element at the corresponding index of M is created to point to S[j].

The worst case time complexity for this second version of SIAME is O(mn log(mn)). The nested loops at lines 37 take time O(mn), and it is well-known that merge sort has a worst case time complexity of N log N for sorting N objects. The function MERGEDUPLICATES runs in time O(nm), since every location of S is visited exactly once (note that the inner loop is executed k times, after which the outer loop variable j is updated to j+k).

Instead of using merge sort and MERGEDUPLICATES, one possibility would have been to sort S “on-the-fly” within the nested loops of SIAME₂ by using, e.g., insertion sort (Weiss, 1993). This would, however, lead to a worst-case time-complexity of O((nm)²) (the case where the vectors are given in reversed order).

References

Borowski, E. J. and Borwein, J. M. (1989). Dictionary of Mathematics. Collins.

Cormen, T. H., Leiserson, C. E., and Rivest, R. L. (1990). Introduction to Algorithms. M.I.T. Press, Cambridge, Mass.

Crochemore, M. and Rytter, W. (1994). Text Algorithms. Oxford University Press, Oxford.

Gusfield, D. (1997). Algorithms on Strings, Trees and Sequences: Computer Science and Computational Biology. Cambridge University Press, Cambridge.

Weiss, M. A. (1993). Data Structures and Algorithm Analysis in C. Benjamin Cummings, Redwood City, Calif.

1. A method of pattern discovery in a dataset, in which the dataset is represented as a set of datapoints in an n-dimensional space, comprising the step of computing inter-datapoint vectors.

2. The method of claim 1, adapted to identify translation invariant sets of datapoints within the dataset, comprising the further steps of:
(a) computing the largest set of datapoints that can be translated by a given inter-datapoint vector to another set of datapoints in the dataset; and
(b) computing all sets of datapoints which are translationally equivalent to the largest set identified in step (a).

3. The method of claim 2 used for any of the following purposes:
(a) lossless data-compression;
(b) predicting the future price of a tradable commodity;
(c) locating repeating elements in a molecule
(d) indexing.

4. The method of claim 1, adapted to identify the occurrence of a user supplied set of datapoints in a dataset, comprising the further steps of:
(a) computing inter-datapoint vectors from each datapoint in the user supplied set of datapoints to each datapoint in the dataset;
(b) computing the largest set of datapoints in the user supplied set of datapoints that can be translated by a given inter-datapoint vector to another set of datapoints in the dataset.

5. The method of claim 4 used for. any of the following purposes:
(a) locating specific elements in a molecule;
(b) visual pattern comparison;
(c) speech or music recognition.

6. The method of any preceding claim in which the datapoints in an n-dimensional space represent any of the following:
(a) audio data;
(b) 2D image data;
(c) 3D representations of virtual spaces;
(d) video data;
(e) molecular structure;
(f) chemical spectra;
(g) financial data;
(h) seismic data;
(i) meteorological data;
(j) symbolic music representations;
(k) CAD circuit data.

7. Computer software adapted to perform the method of any preceding claim 1-6.
